(19) United States
(12) Patent Application Publication
(10) Pub. No.: US 2026/0255399 A1
(43) Pub. Date: Aug. 27, 2026

(54) MIXED RANDOM ACCESS CHANNEL CONFIGURATIONS

(71) Applicant: QUALCOMM Incorporated, San Diego, CA (US)

(72) Inventors: Navid ABEDINI, Basking Ridge, NJ (US); Tao LUO, San Diego, CA (US); Xiaoxia ZHANG, San Diego, CA (US); Jianghong LUO, Skillman, NJ (US); Junyi LI, Greentown, PA (US)

(21) Appl. No.: 19/437,683

(22) Filed: Dec. 31, 2025

Related U.S. Application Data
(60) Provisional application No. 63/764,187, filed on Feb. 27, 2025.

(51) Int. Cl. H04W 74/0833; H04L 47/283; H04W 74/00

(52) U.S. Cl. CPC H04W 74/0833; H04L 47/283; H04W 74/002

(57) ABSTRACT

Various aspects of the present disclosure generally relate to wireless communication. In some aspects, a first network entity may receive configuration information indicating a first random access channel configuration and a second random access channel configuration. The first network entity may transmit a first random access communication in accordance with the first random access channel configuration. The first network entity may transmit, based on the first random access communication being unsuccessful and based on one or more conditions being satisfied, a second random access communication in accordance with the second random access channel configuration. Numerous other aspects are described.

### CROSS-REFERENCE TO RELATED APPLICATION

This Patent Application claims priority to U.S. Provisional Patent Application No. 63/764,187, filed on Feb. 27, 2025, entitled “MIXED RANDOM ACCESS CHANNEL CONFIGURATIONS,” and assigned to the assignee hereof. The disclosure of U.S. Provisional Patent Application No. 63/764,187 is considered part of and is incorporated by reference into this Patent Application in its entirety.

### FIELD OF THE DISCLOSURE

Aspects of the present disclosure generally relate to wireless communication and specifically relate to techniques, apparatuses, and methods associated with mixed random access channel configurations.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE) in some wireless communication systems may perform one or more procedures for establishing a communications link with a network node that is operating as part of a wireless communication network. The UE may communicate a series of messages with the network node to establish access to the network. In some examples, establishing access to the network may be referred to as initial access. In some examples, the UE may perform a random access procedure to establish access to the wireless communication network via the network node (e.g., to establish a communication connection including an uplink connection or a downlink connection). In some examples, the random access procedure may also be referred to as a random access channel (RACH) procedure. In some examples, the UE may perform a random access procedure, such as a four-step random access procedure or a two-step random access procedure.

### SUMMARY

The systems, methods, and devices of this disclosure each have several innovative aspects, no single one of which is solely responsible for the desirable attributes disclosed herein.

Some aspects described herein relate to a first network entity. The first network entity may include a processing system. The processing system may be configured to receive configuration information indicating a first random access channel configuration and a second random access channel configuration. The processing system may be configured to transmit a first random access communication in accordance with the first random access channel configuration. The processing system may be configured to transmit, based on the first random access communication being unsuccessful and based on one or more conditions being satisfied, a second random access communication in accordance with the second random access channel configuration.

Some aspects described herein relate to a first network entity. The first network entity may include a processing system. The processing system may be configured to transmit configuration information indicating a first random access channel configuration and a second random access channel configuration. The processing system may be configured to receive a first random access communication in accordance with the first random access channel configuration, wherein the first random access communication is associated with a second network entity. The processing system may be configured to receive, based on one or more conditions being satisfied, a second random access communication in accordance with the second random access channel configuration, wherein the second random access communication is associated with the second network entity.

Some aspects described herein relate to a method of wireless communication performed by a first network entity. The method may include receiving configuration information indicating a first random access channel configuration and a second random access channel configuration. The method may include transmitting a first random access communication in accordance with the first random access channel configuration. The method may include transmitting, based on the first random access communication being unsuccessful and based on one or more conditions being satisfied, a second random access communication in accordance with the second random access channel configuration.

Some aspects described herein relate to a method of wireless communication performed by a first network entity. The method may include transmitting configuration information indicating a first random access channel configuration and a second random access channel configuration. The method may include receiving a first random access communication in accordance with the first random access channel configuration, wherein the first random access communication is associated with a second network entity. The method may include receiving, based on one or more conditions being satisfied, a second random access communication in accordance with the second random access channel configuration, wherein the second random access communication is associated with the second network entity.

Some aspects described herein relate to a non-transitory computer-readable medium having code stored thereon. The code, when executed by a network entity, may cause the network entity to receive configuration information indicating a first random access channel configuration and a second random access channel configuration. The code, when executed by a network entity, may cause the network entity to transmit a first random access communication in accordance with the first random access channel configuration. The code, when executed by a network entity, may cause the network entity to transmit, based on the first random access communication being unsuccessful and based on one or more conditions being satisfied, a second random access communication in accordance with the second random access channel configuration.

Some aspects described herein relate to a non-transitory computer-readable medium having code stored thereon. The code, when executed by a network entity, may cause the network entity to transmit configuration information indicating a first random access channel configuration and a second random access channel configuration. The code, when executed by a network entity, may cause the network entity to receive a first random access communication in accordance with the first random access channel configuration, wherein the first random access communication is associated with a second network entity. The code, when executed by a network entity, may cause the network entity to receive, based on one or more conditions being satisfied, a second random access communication in accordance with the second random access channel configuration, wherein the second random access communication is associated with the second network entity.

Some aspects described herein relate to an apparatus for wireless communication. The apparatus may include means for receiving configuration information indicating a first random access channel configuration and a second random access channel configuration. The apparatus may include means for transmitting a first random access communication in accordance with the first random access channel configuration. The apparatus may include means for transmitting, based on the first random access communication being unsuccessful and based on one or more conditions being satisfied, a second random access communication in accordance with the second random access channel configuration.

Some aspects described herein relate to an apparatus for wireless communication. The apparatus may include means for transmitting configuration information indicating a first random access channel configuration and a second random access channel configuration. The apparatus may include means for receiving a first random access communication in accordance with the first random access channel configuration, wherein the first random access communication is associated with a second network entity. The apparatus may include means for receiving, based on one or more conditions being satisfied, a second random access communication in accordance with the second random access channel configuration, wherein the second random access communication is associated with the second network entity.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIG. 3 is a diagram illustrating an example disaggregated network node architecture.

FIG. 4 is a diagram illustrating an example of a two-step random access procedure.

FIG. 5 is a diagram illustrating an example of a four-step random access procedure.

FIG. 6 is a diagram of an example associated with mixed random access channel configurations.

FIG. 7 is a diagram illustrating an example process performed, for example, at a first network entity or an apparatus of a first network entity.

FIG. 8 is a diagram illustrating an example process performed, for example, at a first network entity or an apparatus of a first network entity.

FIG. 9 is a diagram of an example apparatus for wireless communication.

FIG. 10 is a diagram of an example apparatus for wireless communication.

### DETAILED DESCRIPTION

In some examples, a user equipment (UE) may perform a random access procedure (e.g., a random access channel (RACH) procedure) with a network node to enable the UE to establish a connection with the network node, such as for an initial access, a link recovery, or a beam failure recovery, among other examples.

As part of a four-step random access procedure, the UE may transmit, and the network node may receive, a first message (msg1) via a physical random access channel (PRACH). The msg1 may include a PRACH preamble. The UE may receive, and the network node may transmit, a second message (msg2) via a physical downlink control channel (PDCCH) or via a physical downlink shared channel (PDSCH) based on transmitting the msg1. The msg2 may include a random access response (RAR) message that schedules a physical uplink shared channel (PUSCH) transmission by the UE. For example, the msg2 may indicate or allocate uplink resources via which the UE may transmit a PUSCH message. The UE may transmit, and the network node may receive, a third message (msg3) including the PUSCH message or the UE may transmit, and the network node may receive, the msg3 via the PUSCH resources. The UE may receive, and the network node may transmit, a fourth message (msg4) that includes a contention resolution message via the PDCCH or PDSCH. For example, the UE may analyze the contention resolution message to identify whether the msg4 includes identification information (e.g., a radio network temporary identifier) that matches with the identification information of the UE (e.g., as opposed to identification information associated with a different UE). If the msg4 includes identification information associated with the UE, the UE may proceed with establishing the connection. Otherwise, the UE may restart the four-step random access procedure, for example, by retransmitting the msg1 or transmitting a second msg1.

As part of a two-step random access procedure, the UE may transmit, and the network node may receive, a first message (msgA) including a PRACH preamble and including content similar to the content of the msg3 of the four-step random access procedure, described above. The msgA transmission may include two transmissions. For example, a first transmission may include a PRACH preamble via the PRACH, and may include timing information for uplink transmissions (e.g., timing information that enables the network node to set timing advance parameters). A second transmission may include the remaining content of the msgA. For example, the msgA may additionally include a payload (e.g., a data payload) transmitted via the PUSCH that includes at least the msg3 contents. In some examples, the UE may transmit, and the network node may receive, a second message (msgB) including content similar to the contents of msg2 or msg4 of the four-step random access procedure.

An initial uplink random access communication transmitted from a UE to a network node (e.g., a msg1 communication in a four-step random access procedure, or a preamble portion of a msgA communication in a two-step random access procedure) may include a preamble sequence that is generated or selected by the UE. The UE and the network node may use the preamble sequence to uniquely identify the UE during the random access procedure. For example, the network node may use the preamble sequence and a random access radio network temporary identifier (RA-RNTI) to address a downlink random access communication to the UE (e.g., a msg2 communication in a four-step random access procedure, or a msgB communication in a two-step random access procedure). For example, a PRACH preamble may include a cyclic prefix, one or more preamble sequences, and a guard period. The UE may generate the preamble sequence based on a root sequence (e.g., a Zadoff-Chu (ZC) sequence) and a cyclic shift. For example, the UE may apply a first cyclic shift of L sample periods to a given root sequence to generate a first preamble sequence. Another UE in the same geographic area may apply a second cyclic shift of K sample periods to the given root sequence to generate a second preamble sequence (e.g., that is distinct from the first preamble sequence).

Because the initial uplink random access communication transmitted from a UE to a network node is performed without uplink timing synchronization, a network node may configure a random access channel configuration to accommodate a range of round-trip times (RTTs) for a coverage area supported by the network node (e.g., for a cell supported by the network node). “Round-trip time” or “RTT” refers to an amount of time for a signal to be transmitted from a transmitter to a receiver, and for the transmitter to receive a response to the signal from the receiver. For example, UEs located at different distances from a network node may experience different RTTs due to differing propagation delays associated with the different distances. For example, a network node may determine a random access channel configuration based on the range of RTTs that are expected to be experienced by UEs in the coverage area supported by the network node. For example, a cyclic prefix of PRACH preambles, a guard period of PRACH preambles, a subcarrier spacing (SCS), supported PRACH format, or a quantity of cyclic shifts available for preamble sequence generation, among other examples, may be configured to accommodate the range of RTTs. However, the network node may sacrifice network resource utilization efficiency to support a larger range of RTTs for random access.

For example, to support longer RTTs (e.g., for UEs located further from the network node), a longer cyclic prefix may be configured to accommodate the longer time delay in signal propagation. However, for shorter RTTs (e.g., for UEs located closer to the network node), a shorter cyclic prefix may be sufficient and can be used to improve network resource utilization efficiency. As another example, to support longer RTTs, a longer guard period may be configured to accommodate the longer time delay in signal propagation, whereas for shorter RTTs a shorter guard period could be used. As another example, to support longer RTTs, PRACH formats with longer preamble durations may be configured to provide more flexibility in timing of transmissions (e.g., to account for longer propagation delays), whereas PRACH formats with shorter preamble durations could be used for shorter RTTs to improve network resource utilization efficiency. As another example, to support longer RTTs, less cyclic shifts may be used so that there is a larger spacing between cyclic shifts used by UEs (e.g., to reduce risk of misdetections by the network node caused by the timing misalignment from long propagation delays). However, for shorter RTTs, a larger quantity of cyclic shifts could be used (e.g., because propagation delays are shorter and the network node can more easily distinguish between different cyclic shifts), thereby improving system capacity (e.g., because more cyclic shifts are available for use by UEs, there are more distinguishable preambles available for use by the UEs enabling more UEs to access the wireless communication network at a given time).

Therefore, a common random access channel configuration for all UEs within a coverage area of a network node may be inefficient because the random access channel configuration may sacrifice network resource utilization efficiency or system capacity in order to support longer RTTs (e.g., to support UEs accessing the wireless communication network from further distances from the network node). In some examples, the network node may configure two (or more) random access channel configurations for different sets of UEs (e.g., a first random access channel configuration for UEs closer to the network node and a second random access channel configuration for UEs further from the network node), such as in integrated access and backhaul (IAB) network deployments. However, by the network node configuring the multiple random access channel configurations, the network node may allocate and monitor periodic time-frequency resources (e.g., PRACH occasions) for each random access channel configuration because all of the multiple random access channel configurations are available for use by UEs. A PRACH occasion may be time-frequency resources available for transmission of an initial message of a random access procedure, such as a msg1 communication in a four-step random access procedure, or a preamble portion of a msgA communication in a two-step random access procedure. This consumes network resources (e.g., as the allocated periodic time-frequency resources are unavailable for the network node to allocate for another purpose) and consumes processing resources or energy resources of the network node associated with monitoring the periodic time-frequency resources (e.g., PRACH occasions) for each random access channel configuration.

Various aspects relate generally to mixed random access channel configurations. Some aspects more specifically relate to a network node configuring multiple random access channel configurations where an availability of use of one or more of the random access channel configurations is subject to one or more conditions. In some aspects, the network node may transmit, and a UE may receive, a first random access channel configuration and a second random access channel configuration. The first random access channel configuration may be a baseline random access channel configuration (e.g., that is always available for use by UEs that receive the first random access channel configuration). The second random access channel configuration may be a conditional random access channel configuration that can only be used by a UE if one or more conditions are satisfied.

For example, the UE may perform a first attempt of a random access procedure in accordance with the first random access channel configuration (e.g., using one or more PRACH formats, PRACH occasions, or other random access channel configuration information indicated by the first random access channel configuration). For example, the UE may transmit a first random access communication (e.g., a msg1 communication in a four-step random access procedure, or a msgA communication in a two-step random access procedure) in accordance with the first random access channel configuration. If the first attempt of the random access procedure is unsuccessful, then the UE may perform a second attempt of a random access procedure in accordance with the second random access channel configuration based on the one or more conditions being satisfied.

In some aspects, the first random access channel configuration may be associated with (e.g., may be configured or designed for) one or more first RTTs and the second random access channel configuration may be associated with (e.g., may be configured or designed for) one or more second RTTs. As an example, the first random access channel configuration may be associated with (e.g., may be configured or designed for) RTTs that do not satisfy an RTT threshold (e.g., for UEs located closer to the network node) and the second random access channel configuration may be associated with (e.g., may be configured or designed for) RTTs that satisfy the RTT threshold (e.g., for UEs located further from the network node).

In some aspects, the one or more conditions may include the UE receiving an RAR communication during the first attempt of the random access procedure that indicates a next preamble relative to the preamble sequence indicated by the UE in the first random access communication. As used herein, “next” preamble of a given preamble refers to a preamble having a random access preamble identifier (RAPID) that is incremented by an increment relative to the RAPID of the given preamble. As an example, a root sequence may be associated with four preamble sequences (e.g., associated with respective cyclic shifts) denoted by RAPIDs N, N+1, N+2, and N+3. A next preamble of the preamble with the RAPID N may be the preamble with the RAPID N+1. In such examples, a next preamble of the preamble with the RAPID N+3 (e.g., the last RAPID in an order of RAPIDs for the root sequence) may be the preamble with the RAPID N (e.g., the first RAPID in the order of RAPIDs). In such examples, the UE receiving the RAR communication that indicates the next preamble may indicate that a propagation delay caused a misdetection of the preamble indicated by the UE.

In some aspects, the one or more conditions may include the UE receiving (e.g., in the RAR communication or another communication) an indication that the second random access channel configuration is available for use. Additionally, or alternatively, the one or more conditions may be based on measurement information obtained by the UE associated with the network node. For example, the one or more conditions may be satisfied based on one or more measurement values satisfying one or more thresholds. Additionally, or alternatively, the one or more conditions may be based on a classification of the UE (e.g., a type of UE, a power class of the UE, a mobility level of the UE, or another classification of the UE). For example, the one or more conditions may be satisfied based on the UE having a classification for which the second random access channel configuration is available for use.

Particular aspects of the subject matter described in this disclosure can be implemented to realize one or more of the following potential advantages. In some examples, the described techniques can be used to improve both the network resource utilization efficiency or system capacity (e.g., for UEs located closer to a given network node) and increase the range of RTTs supported for random access with the given network node without significantly increasing resource allocation or monitoring overhead for the network node. For example, by the UE using the second random access channel configuration subject to the one or more conditions being satisfied, the UE may only apply the second random access channel configuration in scenarios that are indicative of a failure of a random access procedure using the first random access procedure being caused by an RTT (or propagation delay) of the UE being too large. For example, the one or more conditions being satisfied based on an RAR communication indicating a next preamble relative to a preamble transmitted by the UE may enable the UE to apply the second random access channel configuration in scenarios that are indicative of a failure of a random access procedure using the first random access procedure being caused by an RTT (or propagation delay) of the UE being too large (e.g., because the network node detecting the next preamble may indicate that the misdetection is caused by the network node misdetecting the cyclic shift applied by the UE due to a large propagation delay). Additionally, by the second random access channel configuration being conditional, the network node can skip monitoring one or more PRACH occasions for the second random access channel configuration in certain scenarios (such as when the second random access channel configuration is not available for use, or activated for, any UEs), thereby conserving network resources, processing resources, or energy resources, among other examples.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

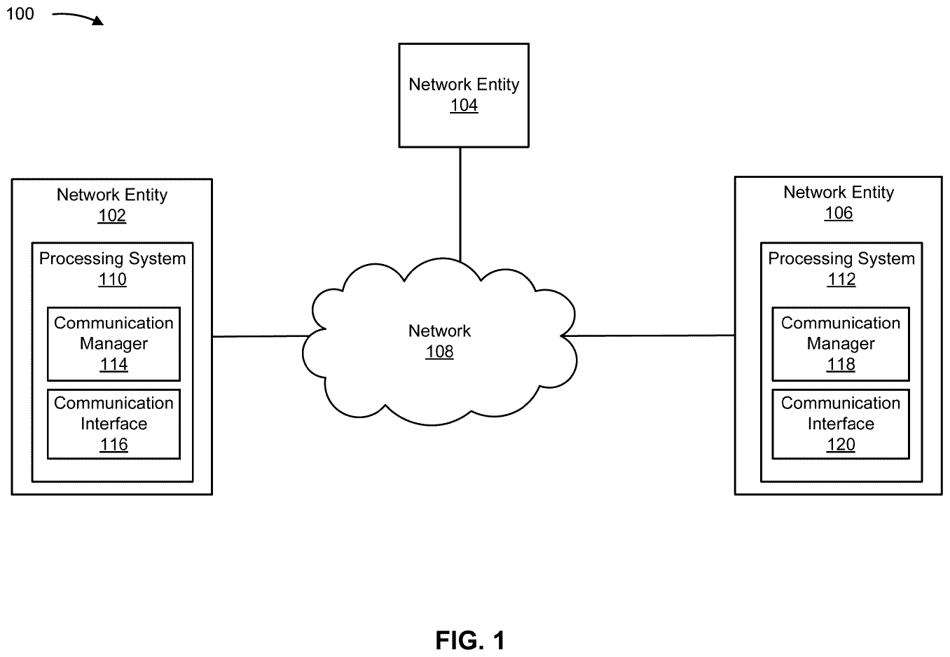

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

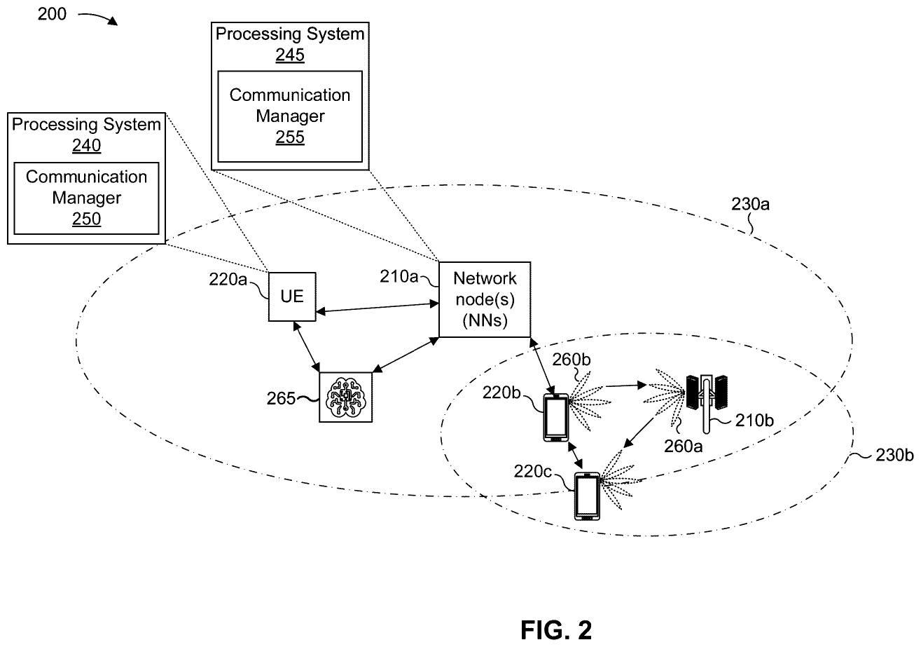

The network 108 may include, for example, a cellular network (e.g., a Long-Term Evolution (LTE) network, a code division multiple access (CDMA) network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 or the communication interface 116 to) receive configuration information indicating a first random access channel configuration and a second random access channel configuration; transmit a first random access communication in accordance with the first random access channel configuration; and transmit, based on the first random access communication being unsuccessful and based on one or more conditions being satisfied, a second random access communication in accordance with the second random access channel configuration. Additionally, or alternatively, the network entity 102 or the communication manager 114 may perform one or more other operations described herein.

As described in more detail elsewhere herein, the network entity 106 may (e.g., the processing system 112 may, or the processing system 112 may cause the communication manager 118 or the communication interface 120 to) transmit configuration information indicating a first random access channel configuration and a second random access channel configuration; receive a first random access communication in accordance with the first random access channel configuration, wherein the first random access communication is associated with a second network entity; and receive, based on one or more conditions being satisfied, a second random access communication in accordance with the second random access channel configuration, wherein the second random access communication is associated with the second network entity. Additionally, or alternatively, the network entity 106 or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a and a network node 210b (each of which also may be referred to herein simply as a “network node 210”). The network nodes 210 may support communications with multiple UEs 220. For example, in FIG. 2, the network nodes 210 support communication with a UE 220a, a UE 220b, and a UE 220c (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active BWP defines the operating bandwidth of the UE 220 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 220a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 220a. Non-codebook-based precoding may involve selecting or deriving a precoder based on, or otherwise associated with, one or more downlink or uplink signal measurements. The network node 210a or the UE 220a may transmit the processed downlink or uplink signals, respectively, via one or more antennas.

The network node 210a or the UE 220a may receive uplink signals or downlink signals, respectively, via one or more antennas. The network node 210a or the UE 220a (for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210a or the UE 220a (for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or multi-user MIMO (MU-MIMO), the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 260a, and a UE 220 may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a network entity (e.g., a UE 220) may include a communication manager 250. As described in more detail elsewhere herein, the communication manager 250 may receive configuration information indicating a first random access channel configuration and a second random access channel configuration; transmit a first random access communication in accordance with the first random access channel configuration; and transmit, based on the first random access communication being unsuccessful and based on one or more conditions being satisfied, a second random access communication in accordance with the second random access channel configuration. Additionally, or alternatively, the communication manager 250 may perform one or more other operations described herein.

In some aspects, a network entity (e.g., the network node 210) may include a communication manager 255. As described in more detail elsewhere herein, the communication manager 255 may transmit configuration information indicating a first random access channel configuration and a second random access channel configuration; receive a first random access communication in accordance with the first random access channel configuration, wherein the first random access communication is associated with a second network entity; and receive, based on one or more conditions being satisfied, a second random access communication in accordance with the second random access channel configuration, wherein the second random access communication is associated with the second network entity. Additionally, or alternatively, the communication manager 255 may perform one or more other operations described herein.

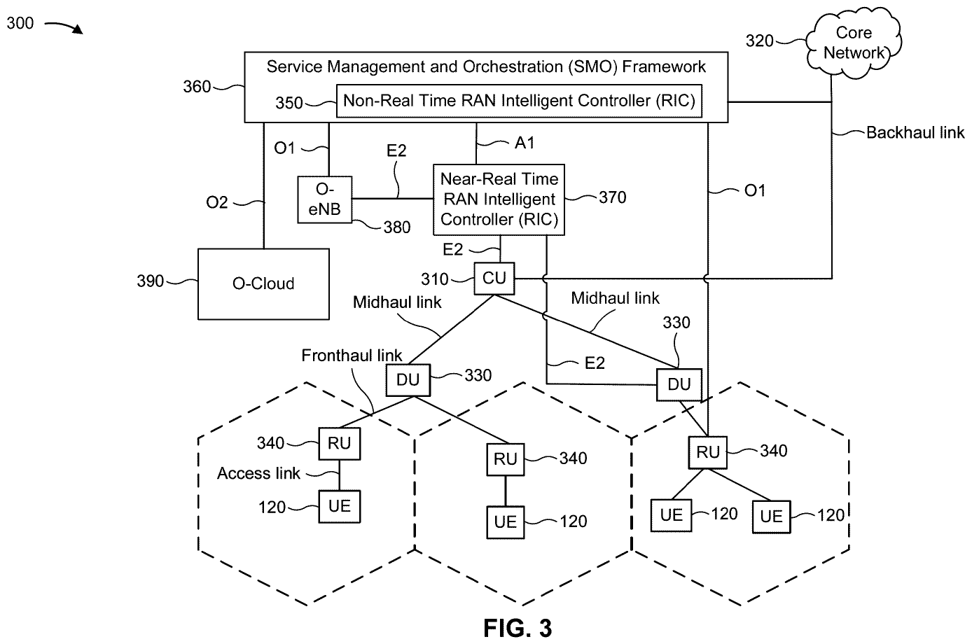

FIG. 3 is a diagram illustrating an example disaggregated network node architecture 300. One or more components of the example disaggregated network node architecture 300 may be, may include, or may be included in one or more network nodes (such one or more network nodes 210). The disaggregated network node architecture 300 may include a CU 310 that can communicate directly with a core network 320 via a backhaul link, or that can communicate indirectly with the core network 320 via one or more disaggregated control units, such as a non-real-time (Non-RT) RAN intelligent controller (RIC) 350 associated with a Service Management and Orchestration (SMO) Framework 360 or a near-real-time (Near-RT) RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 220 via respective RF access links. In some deployments, a UE 220 may be simultaneously served by multiple RUs 340.

Each of the components of the disaggregated network node architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, or a Near-RT RIC 370. In some aspects, the SMO Framework 360 may communicate with a hardware aspect of a 4G RAN, a 5G NR RAN, or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, or policy-based guidance of applications or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, or an O-eNB 380 with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

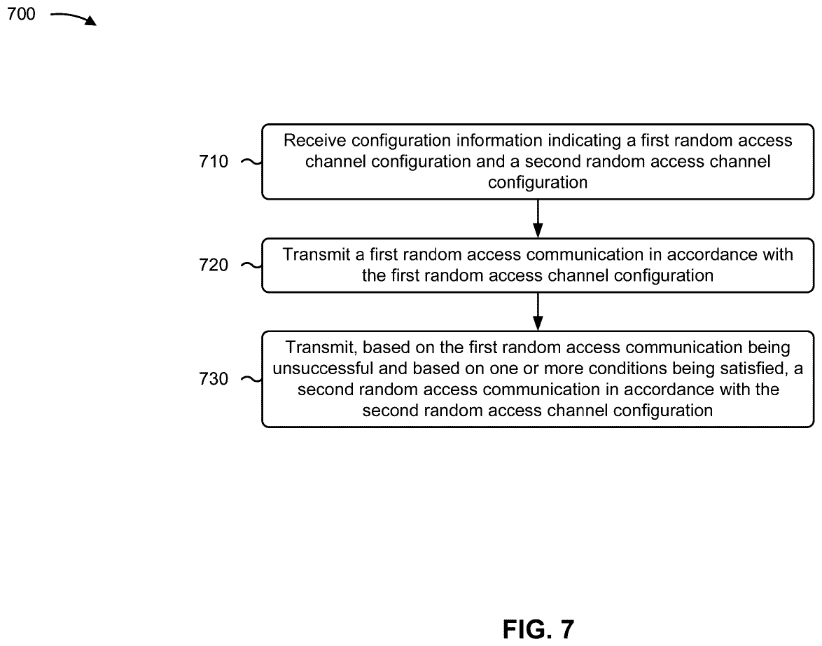

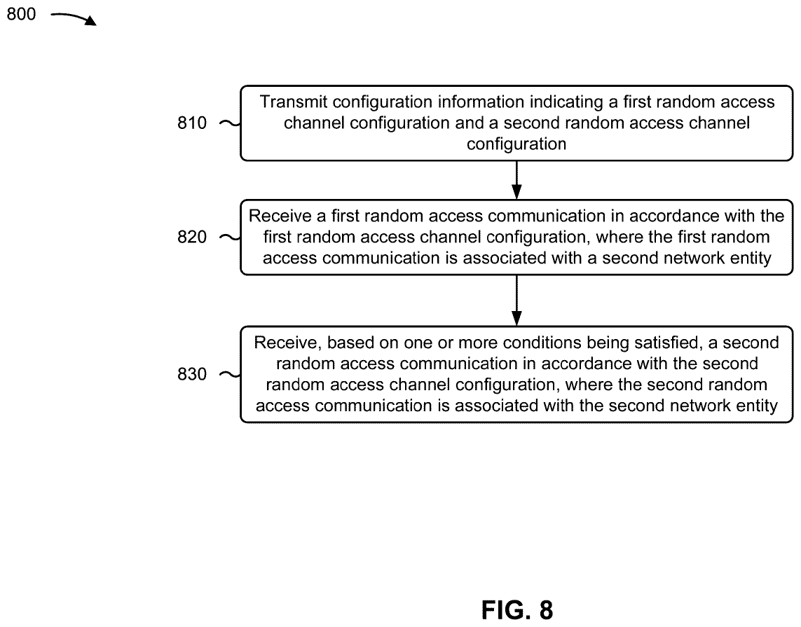

The network entity 102, the processing system 110 of the network entity 102, the network entity 106, the processing system 112 of the network entity 106, the network node 210, the processing system 245 of the network node 210, the UE 220, the processing system 240 of the UE 220, the CU 310, the DU 330, the RU 340, or any other component(s) of FIGS. 1-3 may implement one or more techniques or perform one or more operations associated with mixed random access channel configurations, as described in more detail elsewhere herein. For example, the processing system 110 of the network entity 102, the processing system 112 of the network entity 106, the processing system 245 of the network node 210, the processing system 240 of the UE 220, the CU 310, the DU 330, or the RU 340 may perform or direct operations of, for example, process 700 of FIG. 7, process 800 of FIG. 8, or other processes as described herein (alone or in conjunction with one or more other processors). Memory of the network node 210 may store data and program code (or instructions) for the network node 210, the CU 310, the DU 330, or the RU 340. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, the UE 220, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

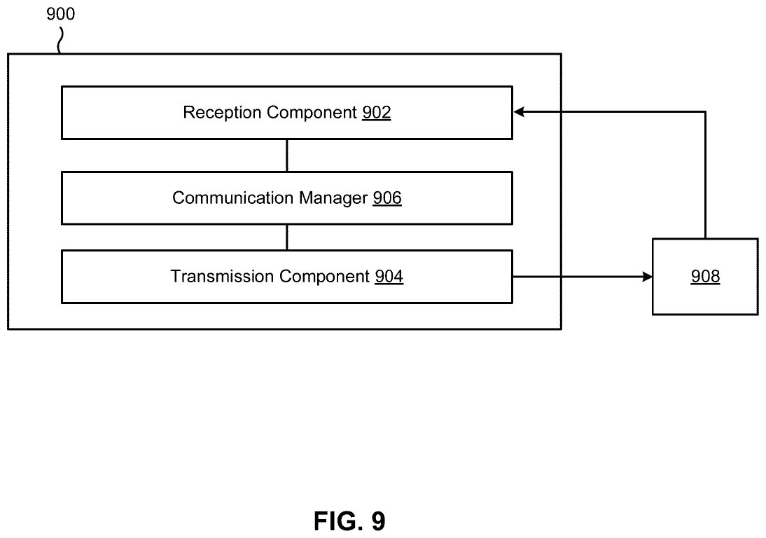

In some aspects, the first network entity includes means for receiving configuration information indicating a first random access channel configuration and a second random access channel configuration; means for transmitting a first random access communication in accordance with the first random access channel configuration; or means for transmitting, based on the first random access communication being unsuccessful and based on one or more conditions being satisfied, a second random access communication in accordance with the second random access channel configuration. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 902 depicted and described in connection with FIG. 9) or a transmission component (for example, transmission component 904 depicted and described in connection with FIG. 9), among other examples.

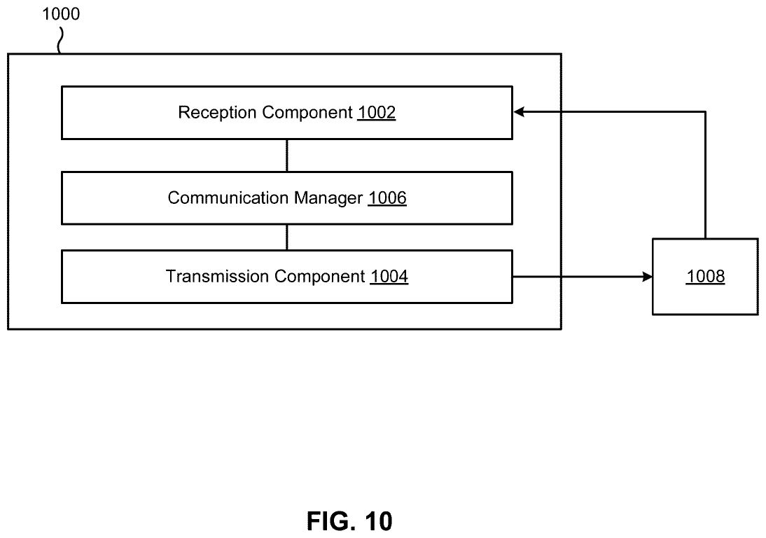

In some aspects, the first network entity includes means for transmitting configuration information indicating a first random access channel configuration and a second random access channel configuration; means for receiving a first random access communication in accordance with the first random access channel configuration, wherein the first random access communication is associated with a second network entity; or means for receiving, based on one or more conditions being satisfied, a second random access communication in accordance with the second random access channel configuration, wherein the second random access communication is associated with the second network entity. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

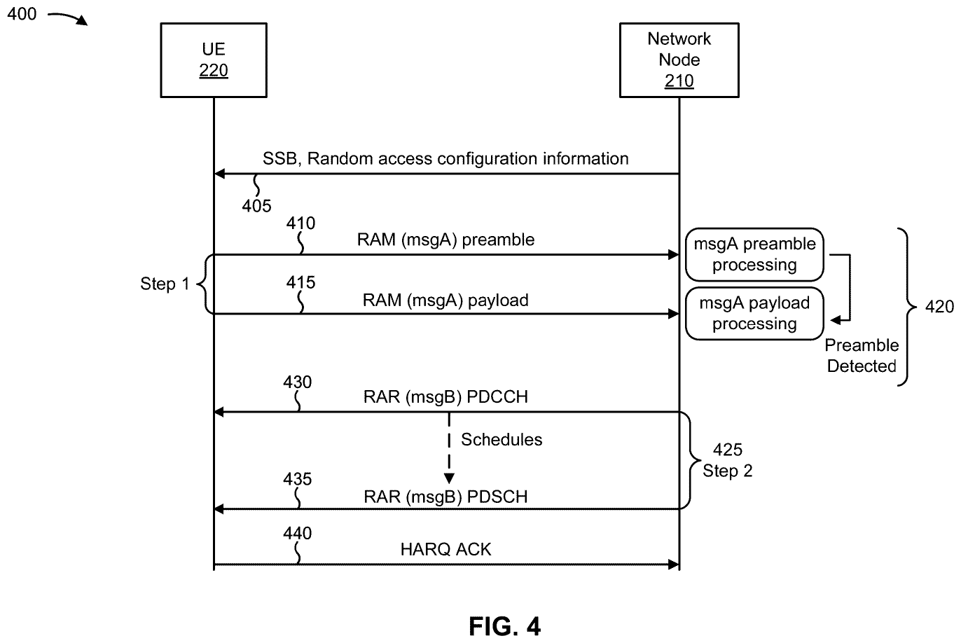

FIG. 4 is a diagram illustrating an example 400 of a two-step random access procedure. As shown in FIG. 4, a network node 210 and a UE 220 may communicate with one another to perform the two-step random access procedure.

As shown by reference number 405, the network node 210 may transmit, and the UE 220 may receive, one or more synchronization signal blocks (SSBs) and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in a radio resource control (RRC) message or a PDCCH order message that triggers a RACH procedure, such as for contention-free random access. The random access configuration information may include one or more parameters to be used in the two-step random access procedure, such as one or more parameters for transmitting a random access message (RAM)or receiving a random access response (RAR) to the RAM.

As shown by reference number 410, the UE 220 may transmit, and the network node 210 may receive, a RAM preamble. As shown by reference number 415, the UE 220 may transmit, and the network node 210 may receive, a RAM payload. As shown, the UE 220 may transmit the RAM preamble and the RAM payload to the network node 210 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), or a PUSCH transmission).

As shown by reference number 420, the network node 210 may receive the RAM preamble transmitted by the UE 220. If the network node 210 successfully receives and decodes the RAM preamble, the network node 210 may then receive and decode the RAM payload.

As shown by reference number 425, the network node 210 may transmit an RAR (sometimes referred to as an RAR message). As shown, the network node 210 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 430, as part of the second step of the two-step random access procedure, the network node 210 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 435, as part of the second step of the two-step random access procedure, the network node 210 may transmit the PDSCH communication for the RAR, as scheduled by the PDCCH communication. The RAR may be included in a MAC protocol data unit (PDU) of the PDSCH communication. As shown by reference number 440, if the UE 220 successfully receives the RAR, the UE 220 may transmit a hybrid automatic repeat request (HARQ) acknowledgement (ACK).

As indicated above, FIG. 4 is provided as an example. Other examples may differ from what is described with regard to FIG. 4.

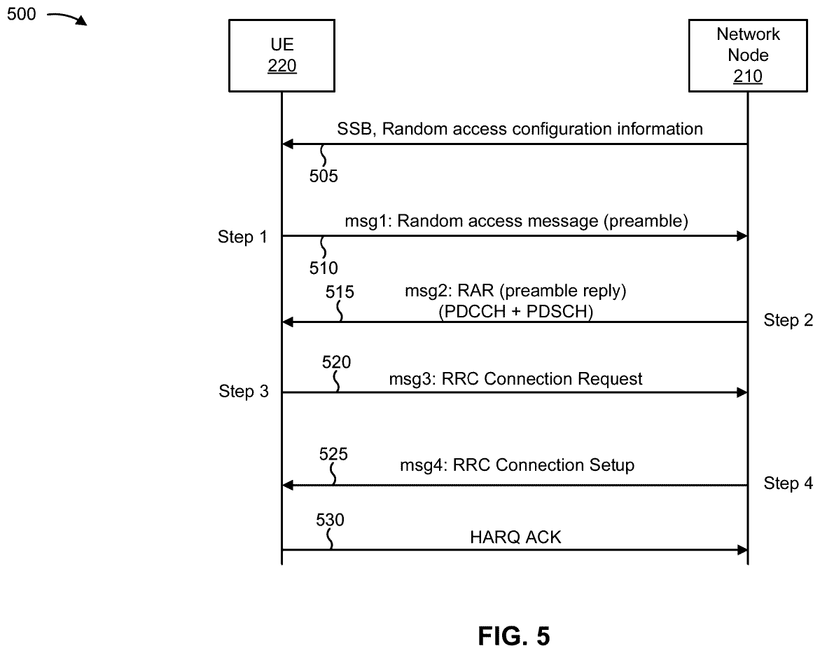

FIG. 5 is a diagram illustrating an example 500 of a four-step random access procedure. As shown in FIG. 5, a network node 210 and a UE 220 may communicate with one another to perform the four-step random access procedure.

As shown by reference number 505, the network node 210 may transmit, and the UE 220 may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in a RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 510, the UE 220 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 515, the network node 210 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 220 in msg1). Additionally, or alternatively, the RAR may indicate a resource allocation to be used by the UE 220 to transmit message 3 (msg3).

In some aspects, as part of the second step of the four-step random access procedure, the network node 210 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 210 may transmit the PDSCH communication for the RAR, as scheduled by the PDCCH communication. The RAR may be included in a MAC PDU of the PDSCH communication.

As shown by reference number 520, the UE 220 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 525, the network node 210 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 530, if the UE 220 successfully receives the RRC connection setup message, the UE 220 may transmit a HARQ ACK.

An initial uplink random access communication transmitted from a UE to a network node (e.g., a msg1 communication in the four-step random access procedure as shown by reference number 510, or a preamble portion of a msgA communication in a two-step random access procedure as shown by reference number 410 in FIG. 4) may include a preamble sequence that is generated or selected by the UE 220. The UE 220 and the network node may use the preamble sequence to uniquely identify the UE 220 during the random access procedure. For example, the network node 210 may use the preamble sequence and an RA-RNTI to address a downlink random access communication to the UE 220 (e.g., a msg2 communication in a four-step random access procedure as shown by reference number 515, or a msgB communication in a two-step random access procedure as shown by reference number 430 and reference number 435 in FIG. 4). For example, a PRACH preamble may include a cyclic prefix, one or more preamble sequences, and a guard period. The UE 220 may generate the preamble sequence based on a root sequence (e.g., a ZC sequence) and a cyclic shift.

Because the initial uplink random access communication transmitted from a UE to a network node is performed without uplink timing synchronization, a network node may configure a random access configuration to accommodate a range of RTTs for a coverage area supported by the network node (e.g., for a cell supported by the network node). For example, UEs 220 located at different distances from a network node may experience different RTTs due to differing propagation delays associated with the different distances. For example, a network node may determine a random access configuration based on the range of RTTs that are expected to be experienced by UEs 220 in the coverage area supported by the network node. For example, a cyclic prefix of PRACH preambles, a guard period of PRACH preambles, a subcarrier spacing (SCS), supported PRACH format, or a quantity of cyclic shifts available for preamble sequence generation, among other examples, may be configured to accommodate the range of RTTs. However, the network node may sacrifice network resource utilization efficiency to support a larger range of RTTs for random access.

For example, to support longer RTTs (e.g., for UEs 220 located further from the network node), a longer cyclic prefix may be configured to accommodate the longer time delay in signal propagation. However, for shorter RTTs (e.g., for UEs 220 located closer to the network node), a shorter cyclic prefix may be sufficient and can be used to improve network resource utilization efficiency. As another example, to support longer RTTs, a longer guard period may be configured to accommodate the longer time delay in signal propagation, whereas for shorter RTTs a shorter guard period could be used. As another example, to support longer RTTs, PRACH formats with longer preamble durations may be configured to provide more flexibility in timing of transmissions (e.g., to account for longer propagation delays), whereas PRACH formats with shorter preamble durations could be used for shorter RTTs to improve network resource utilization efficiency. As another example, to support longer RTTs, less cyclic shifts may be used so that there is a larger spacing between cyclic shifts used by UEs (e.g., to reduce risk of misdetections by the network node caused by the timing misalignment from long propagation delays). However, for shorter RTTs, a larger quantity of cyclic shifts could be used (e.g., because propagation delays are shorter and the network node can more easily distinguish between different cyclic shifts), thereby improving system capacity (e.g., because more cyclic shifts are available for use by UEs 220, there are more distinguishable preambles available for use by the UEs 220 enabling more UEs 220 to access the wireless communication network at a given time).

Therefore, a common random access configuration for all UEs within a coverage area of a network node 210 may be inefficient because the random access configuration may sacrifice network resource utilization efficiency or system capacity in order to support longer RTTs (e.g., to support UEs 220 accessing the wireless communication network from further distances from the network node). In some examples, the network node 210 may configure two (or more) random access configurations for different sets of UEs (e.g., a first random access configuration for UEs closer to the network node and a second random access configuration for UEs further from the network node). However, by the network node 210 configuring the multiple random access configurations, the network node may allocate and monitor periodic time-frequency resources (e.g., PRACH occasions) for each random access configuration because all of the multiple random access configurations are available for use by UEs. This consumes network resources (e.g., as the allocated periodic time-frequency resources are unavailable for the network node 210 to allocate for another purpose) and consumes processing resources or energy resources of the network node associated with monitoring the periodic time-frequency resources (e.g., PRACH occasions) for each random access configuration.

As indicated above, FIG. 5 is provided as an example. Other examples may differ from what is described with regard to FIG. 5.

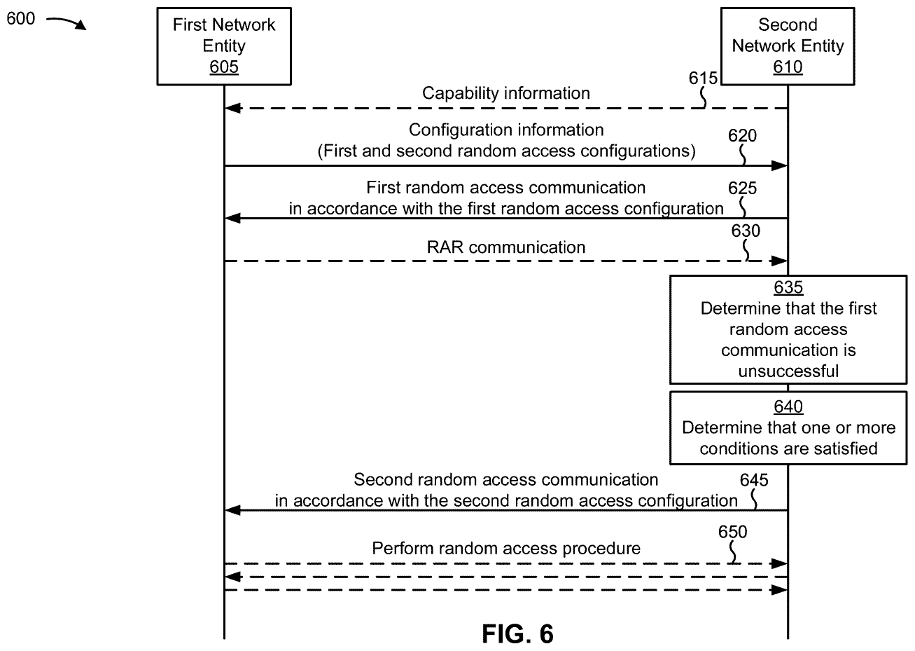

FIG. 6 is a diagram of an example 600 associated with mixed random access channel configurations. As shown in FIG. 6, a first network entity 605 (e.g., the network entity 102, the network entity 106, or a network node 210) may communicate with a second network entity 610 (e.g., the network entity 102, the network entity 106, or a UE 220). In some aspects, the first network entity 605 and the second network entity 610 may be part of a wireless network (e.g., the wireless communication network 200).

In some aspects, as shown by reference number 615, the second network entity 610 may transmit capability information. The capability information may be included in a capability report. The second network entity 610 may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, an RRC communication, a physical uplink control channel (PUCCH), a PUSCH, a physical sidelink control channel (PSCCH), or a physical sidelink shared channel (PSSCH), among other examples. The capability information may indicate one or more parameters associated with respective capabilities of the second network entity 610. The one or more parameters may be indicated via respective information elements (IEs) included in a capability report.

The capability information may indicate whether the second network entity 610 supports a feature or one or more parameters related to the feature. For example, the capability information may indicate a capability or parameter for supporting mixed random access channel configurations (e.g., a baseline random access channel configuration and one or more conditional random access channel configurations). As another example, the capability information may indicate a capability or parameter for applying a random access channel configuration (e.g., a conditional random access configuration) based on one or more conditions being satisfied. One or more operations described herein may be based on capability information. For example, the second network entity 610 may perform a communication in accordance with the capability information, or may receive configuration information that is in accordance with the capability information.

In some aspects, the capability information may indicate support for one or more types of random access channel configurations for mixed random access channel configurations. For example, a first type of random access channel configuration may include a first random access channel configuration (e.g., a baseline random access channel configuration) and a second random access channel configuration (e.g., a conditional random access channel configuration for longer RTTs) sharing PRACH resources (e.g., PRACH occasions). The first type of random access channel configuration may be associated with UEs performing timing advance pre-compensation (e.g., based on a size of a cyclic shift gap between preambles associated with the first random access channel configuration) for transmissions that are in accordance with the second random access channel configuration. A second type of random access channel configuration may include a first random access channel configuration (e.g., a baseline random access channel configuration) and a second random access channel configuration (e.g., a conditional random access channel configuration for longer RTTs) being configured with separate PRACH resources (e.g., separate PRACH occasions).

As shown by reference number 620, the first network entity 605 may transmit, and the second network entity 610 may receive, configuration information. In some aspects, the second network entity 610 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the second network entity 610 or previously indicated by the network node or other network device), or explicit configuration information for the second network entity 610 to use to configure the second network entity 610, among other examples.

In some examples, the configuration information may not be expressly signaled to the second network entity 610. For example, in some aspects, the configuration information may at least partially be defined by a wireless communication standard, such as the 3GPP. In such examples, the first network entity 605 may not explicitly indicate such configuration information to the second network entity 610. For example, the second network entity 610 may optionally obtain at least a portion of the configuration information from a configuration stored by the second network entity 610 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may include a first random access channel configuration and a second random access channel configuration. As used herein, “random access channel configuration” may refer to one or more PRACH resources (e.g., one or more PRACH occasions), one or more PRACH formats, one or more PRACH preambles, or other random access configuration information. For example, as used herein, the first and second random access channel configurations may be included in a single configuration and may sub-configurations or sub-elements (e.g., different PRACH resources, PRACH occasions, or PRACH formats) within the single configuration. “PRACH occasion” and “random access channel occasion” may be used interchangeably herein.

The first random access channel configuration may be a baseline random access channel configuration. “Baseline” random access channel configuration refers to a random access configuration to be used or applied (such as by the second network entity 610) by default. For example, network entities attempting to establish a communication connection with the first network entity 605 may first attempt to perform a random access procedure in accordance with the baseline random access channel configuration. In contrast, a “conditional” random access channel configuration refers to a random access configuration to be used or applied only when one or more conditions are satisfied. The second random access channel configuration may be a conditional random access channel configuration.

The first random access channel configuration may be associated with one or more first RTTs and the second random access channel configuration may be associated with one or more second RTTs. For example, the one or more first RTTs may satisfy an RTT threshold, and the one or more second RTTs may not satisfy the RTT threshold. As an example, the first random access channel configuration may be associated RTTs that are less than or equal to the RTT threshold. The second random access channel configuration may be associated with RTTs that are greater than the RTT threshold. A random access channel configuration may be associated with one or more RTTs in that the random access channel configuration is configured or designed to support the one or more RTTs. As an example, the first random access channel configuration may not be configured or designed to support the one or more second RTTs (e.g., longer RTTs), thereby improving network resource utilization efficiency or system capacity, among other examples, for network entities associated with the one or more first RTTs (e.g., smaller RTTs). By the first network entity 605 configuring the second random access channel configuration to be conditionally available, the first network entity 605 may conserve network resources, conserve monitoring overhead, or improve resource allocation flexibility, among other examples, associated with resources allocated for the second random access channel configuration.

In some aspects, the second random access channel configuration may share one or more PRACH resources with the first random access channel configuration. For example, the mixed random access channel configuration (e.g., including the first random access channel configuration and the second random access channel configuration) may be the first type of random access channel configuration. In the first type of random access channel configuration, the first random access channel configuration (e.g., a baseline random access channel configuration) and the second random access channel configuration (e.g., a conditional random access channel configuration for longer RTTs) may share PRACH resources (e.g., PRACH occasions). For example, random access configuration information may indicate one or more PRACH occasions. The one or more PRACH occasions may be configured for both the first random access channel configuration and the second random access channel configuration.

If the first type of random access channel configuration is used, then the first random access channel configuration and the second random access channel configuration may use the same one or more preamble identifiers (e.g., the same preambles may be configured or allocated for the first random access channel configuration and the second random access channel configuration). In other examples, a portion of preambles (e.g., preamble identifiers) may be configured for both the first random access channel configuration and the second random access channel configuration. For example, from a set of preamble identifiers, a first subset may be available for both the first random access channel configuration and the second random access channel configuration, a second subset may be available only for the first random access channel configuration, and a third subset may be available only for the second random access channel configuration. In other examples, the first random access channel configuration and the second random access channel configuration may not share any preambles. For example, one or more first preamble identifiers may be configured for the first random access channel configuration and one or more second preamble identifiers may be configured for the second random access channel configuration (e.g., where the one or more first preamble identifiers and the one or more second preamble identifiers are different).

The first type of random access channel configuration may be associated with the second network entity 610 performing timing advance pre-compensation (e.g., based on a size of a cyclic shift gap between preambles associated with the first random access channel configuration) for transmissions that are in accordance with the second random access channel configuration. For example, if the first type of random access channel configuration is used, then the second network entity 610 may pre-compensate a timing advance value (e.g., an uplink timing advance value) with an amount that is associated with a cyclic shift used for preamble sequence generation for the first random access channel configuration. For example, when transmitting in accordance with the second random access channel configuration, the second network entity 610 may use a different timing advance than when transmitting in accordance with the first random access channel configuration. For example, because the second network entity 610 may apply the second random access channel configuration in scenarios that are indicative of longer RTTs, the timing advance applied by the second network entity 610 may be pre-compensated to account for the longer RTT likely being experienced by the second network entity 610.

A second type of random access channel configuration may include the first random access channel configuration and the second random access channel configuration being configured with separate PRACH resources (e.g., separate PRACH occasions). For example, one or more first PRACH occasions may be configured for the first random access channel configuration and one or more second PRACH occasions may be configured for the second random access channel configuration (e.g., where the one or more first PRACH occasions and the one or more second PRACH occasions are different). If the second type of random access channel configuration is used, then the second network entity 610 may not apply timing advance pre-compensation for the second random access channel configuration. In other examples, if the second type of random access channel configuration is used, then the second network entity 610 may apply timing advance pre-compensation for the second random access channel configuration. If the second type of random access channel configuration is used, then the second random access channel configuration may include different PRACH formats than one or more PRACH formats configured for the first random access channel configuration. For example, one or more PRACH formats configured for the second random access channel configuration may be configured or selected for longer RTTs. A PRACH format configured for the second random access channel configuration may have a length (or duration), an SCS, a cyclic prefix, a guard period, or a quantity of cyclic shifts, among other examples, that is configured for longer RTTs. For example, to support longer RTTs, a PRACH format with less cyclic shifts may be used so that there is a larger spacing between cyclic shifts used by UEs (e.g., to reduce risk of misdetections caused by the timing misalignment from long propagation delays), a PRACH format with a longer cyclic prefix may be configured to accommodate the longer time delay in signal propagation, a PRACH format with a longer guard period may be configured to accommodate the longer time delay in signal propagation, or a PRACH format with a longer preamble durations may be configured to provide more flexibility in timing of transmissions (e.g., to account for longer propagation delays), among other examples.

In some aspects, the first network entity 605 may support the first type of random access channel configuration and the second type of random access channel configuration. For example, a cell associated with the first network entity 605 may support both the first type of random access channel configuration and the second type of random access channel configuration. In such examples, the second network entity 610 may determine which type of random access channel configuration is to be applied based on one or more factors. For example, the one or more factors may include which type is indicated in an RAR communication from the first network entity 616050 (e.g., the first network entity 605 may explicit indicate in the RAR communication which type of random access channel configuration is to be applied). Additionally, or alternatively, the one or more factors may include which type is indicated in configuration information. For example, the configuration information may indicate which type of random access channel configuration is to be applied by the second network entity 610. Additionally, or alternatively, the one or more factors may include a classification of the second network entity 610. For example, a certain classification may be configured to apply the first type of random access channel configuration and other classifications may be configured to apply the second type of random access channel configuration. The classification may include a category of the second network entity 610 (e.g., indicating a category of device, such as a baseline device, a customer premises equipment (CPE), a RedCap device, a wireless access and backhaul (WAB) device, or a network-controlled repeater (NCP)), a power classification (e.g., indicating a classification of the level of transmit power), a mobility classification (e.g., stationary, high mobility, low mobility, or medium mobility), or an unmanned ariel vehicle (UAV) classification (e.g., indicating whether the second network entity 610 is included in, or associated with, a UAV), among other examples. Additionally, or alternatively, the one or more factors may include a cause for performing the random access procedure, such as initial access, link recovery, or beam failure recovery, among other examples. For example, certain causes may be associated with the second network entity 610 applying the first type of random access channel configuration and other causes may be associated with the second network entity 610 applying the second type of random access channel configuration.

In some aspects, the configuration information may indicate the one or more conditions for applying the second random access channel configuration. For example, the configuration information may indicate that if the second network entity 610 detects a next preamble (e.g., relative to a preamble that the second network entity 610 indicated in an initial message of a random access communication in accordance with the first random access channel configuration) in an RAR communication, then the second network entity 610 is to re-attempt the initial message in accordance with the second random access channel configuration. Additionally, or alternatively, the configuration information may indicate that the one or more conditions include the RAR communication indicating that the second random access channel configuration is available for use by the second network entity 610. Additionally, or alternatively, the configuration information may indicate that the one or more conditions include one or more measurement conditions. For example, the configuration information may indicate that if a measurement value (such as an estimated or measurement RSRP or pathloss) satisfies a threshold, then the second random access channel configuration is available for use by the second network entity 610. In some aspects, the configuration information may indicate one or more thresholds to be used by the second network entity 610 to evaluate whether the one or more measurement conditions are satisfied.

Additionally, or alternatively, the configuration information may indicate that the one or more conditions include one or more classification conditions. For example, the configuration information may indicate that one or more classifications of network entities (e.g., of UEs) can apply the second random access channel configuration. The classification may include a category of the second network entity 610 (e.g., indicating a category of device, such as a baseline device, a CPE, a RedCap device, a WAB device, or an NCP), a power classification (e.g., indicating a classification of the level of transmit power), a mobility classification (e.g., stationary, high mobility, low mobility, or medium mobility), or a UAV classification (e.g., indicating whether the second network entity 610 is included in, or associated with, a UAV), among other examples. Additionally, or alternatively, the configuration information may indicate that the one or more conditions include the second network entity 610 receiving authorization to apply the second random access channel configuration. For example, the one or more conditions may include prior (e.g., entity-specific or UE-specific) authorization being provided by the first network entity 605 to apply the second random access channel configuration. In some aspects, the configuration information (e.g., an RRC configuration) may include the authorization for the second network entity 610 to apply the second random access channel configuration. In other examples, the authorization may be included in a separate communication, such as a separate RRC communication, MAC-CE communication, or DCI communication.

The second network entity 610 may configure itself based at least in part on the configuration information. In some aspects, the second network entity 610 may be configured to perform one or more operations described herein based at least in part on the configuration information.

In some aspects, the first network entity 605 may receive a request for the second network entity 610 to use or apply the second random access channel configuration. In some aspects, the second network entity 610 may transmit the request. In other examples, another network entity (e.g., another UE) may transmit the request for the second network entity 610 (e.g., using collaboration to enable the request to be provided to the first network entity 605 when the second network entity 610 does not have a communication connection or is not within a communication range of the first network entity 605).

In some aspects, the second network entity 610 may transmit the request when operating in a connected mode (e.g., an RRC connected mode) with the first network entity 605. For example, the request may be a request to apply the second random access channel configuration (e.g., subject to the one or more conditions) for future random access procedures with the first network entity 605. In other examples, the second network entity 610 may transmit the request when operating in an idle mode or an inactive mode (e.g., an RRC idle mode or an RRC inactive mode). In such examples, the second network entity 610 may transmit the request via a wake-up signal (WUS) communication (e.g., an uplink WUS communication or a low-power WUS communication).

As another example, the second network entity 610 may transmit the request via a random access communication (e.g., via a PRACH communication). For example, one or more PRACH resources may be configured for transmitting the request. In some examples, the one or more PRACH resources may be included in, or associated with, the first random access channel configuration. In such examples, the second network entity 610 may transmit the request using a waveform that is designed for longer RTTs. For example, one or more cyclic shifts configured for the first random access channel configuration may be unavailable for random access procedures and may instead be configured to transmissions of requests to apply the second random access channel configuration.

In some aspects, the first network entity 605 may transmit, and the second network entity 610 may receive, a response to the request. The response may indicate whether the second network entity 610 can apply the second random access channel configuration (e.g., subject to the one or more conditions being satisfied) for random access procedures with the first network entity 605. The first network entity 605 may transmit the response via an RAR communication, a control channel-based ACK communication (e.g., a PDCCH-based ACK communication), or a WUS communication (e.g., a downlink WUS communication or a low-power WUS communication), among other examples.

In some aspects, the second network entity 610 may transmit the request based on the one or more conditions being satisfied, in a similar manner as described herein, such as in connection with reference number 640. Additionally, or alternatively, the response transmitted by the first network entity 605 may be based on whether the one or more conditions being satisfied. For example, if the one or more conditions are satisfied, then the response may indicate that the second network entity 610 can apply the second random access channel configuration. If the one or more conditions are not satisfied, then the response may indicate that the second network entity 610 cannot apply the second random access channel configuration. In other examples, the condition(s) for transmitting the request or the response may be different than the one or more conditions used by the second network entity 610 to determine whether to re-attempt random access using the second random access channel configuration, such as described in connection with reference number 640.

As shown by reference number 625, the second network entity 610 may transmit a first random access communication. The first random access communication may be an initial message of a random access procedure. For example, the random access procedure may be a four-step random access procedure and the first random access communication may be a msg1 communication. In some other aspects, the random access procedure may be a two-step random access procedure and the first random access communication may be a msgA communication.

The first random access communication may be in accordance with the first random access channel configuration (e.g., the baseline random access channel configuration). For example, the first random access communication may use one or more PRACH resources (e.g., a PRACH occasion) configured for the first random access channel configuration, a PRACH format configured for the first random access channel configuration, or other PRACH resources indicated by the first random access channel configuration to transmit the first random access communication. The first random access communication may include, or indicate, a preamble. The preamble may be associated with a preamble identifier configured for the first random access channel configuration.

In some aspects, as shown by reference number 630, the first network entity 605 may transmit, and the second network entity 610 may receive, an RAR communication (e.g., after the second network entity 610 transmits the first random access communication). The RAR communication may indicate one or more preambles (e.g., one or more RAPIDs). The RAR communication may be a msg2 communication for a four-step random access procedure or a msgB PDCCH communication of a two-step random access procedure.

As shown by reference number 635, the second network entity 610 may determine that the first random access communication is unsuccessful. For example, the second network entity 610 may determine that the first random access communication is unsuccessful based on the RAR communication including a RAPID that does not correspond to the preamble transmitted by the second network entity 610 in the first random access communication (e.g., as described in connection with reference number 625). As another example, the second network entity 610 may determine that the first random access communication is unsuccessful based on failing to detect an RAR communication during a monitoring window corresponding to the first random access communication.

As shown by reference number 640, the second network entity 610 may determine that the one or more conditions (e.g., for applying the second random access channel configuration) are satisfied. For example, the one or more conditions may be satisfied based on the first random access communication being unsuccessful. Additionally, or alternatively, the second network entity 610 may determine that the one or more conditions are satisfied based on a RAPID indicated by the RAR communication being associated with a next preamble relative to the preamble indicated in the first random access communication. As an example, a root sequence may be associated with four preamble sequences (e.g., associated with respective cyclic shifts) denoted by RAPIDs N, N+1, N+2, and N+3. A next preamble of the preamble with the RAPID N may be the preamble with the RAPID N+1. In such examples, a next preamble of the preamble with the RAPID N+3 (e.g., the last RAPID in an order of RAPIDs for the root sequence) may be the preamble with the RAPID N (e.g., the first RAPID in the order of RAPIDs). In such examples, the second network entity 610 receiving the RAR communication that indicates the next preamble may indicate that a propagation delay caused a misdetection of the preamble indicated by the second network entity 610 in the first random access communication.

Additionally, or alternatively, the second network entity 610 may determine that the one or more conditions are satisfied based on reception of an indication that the second random access channel configuration is available for use. For example, the first network entity 605 may transmit, and the second network entity 610 may receive, an indication that the second random access channel configuration is available for use. In some aspects, the indication that the second random access channel configuration is available for use may be included in the RAR communication. In other aspects, the indication that the second random access channel configuration is available for use may be included in the configuration information. In other aspects, the indication that the second random access channel configuration is available for use may be included in another communication, such as a system information communication (e.g., an SIB), an RRC communication, a MAC-CE communication, or a DCI communication. In some aspects, the one or more conditions may indicate that the indication that the second random access channel configuration is available for use is to be included in a communication directed to (or specific to) the second network entity 610, such as an device-specific (or UE-specific) communication (e.g., the second network entity 610 may apply the second random access configuration based on reception of prior (device-specific) authorization). The second network entity 610 may apply the second random access channel configuration for a re-attempt of the random access procedure based on the reception of the indication that the second random access channel configuration is available for use.

Additionally, or alternatively, the second network entity 610 may determine that the one or more conditions are satisfied based on measurement information associated with the first network entity 605. For example, the second network entity 610 may perform one or more measurements associated with the first network entity 605 to obtain to the measurement information (e.g., the second network entity 610 may measure one or more reference signals, such as a pathloss reference signal or an SSB). The measurement information may indicate one or more measurement values, such as RSRP values, or pathloss values, among other examples. The second network entity 610 may determine that the one or more conditions are satisfied based on the one or more measurement values satisfying one or more thresholds. In some aspects, the configuration information may indicate the one or more thresholds. As an example, the second network entity 610 may determine that the one or more conditions are satisfied based on a measured or estimated pathloss value satisfying a pathloss threshold. For example, the second network entity 610 may apply the second random access channel configuration for a re-attempt of the random access procedure based on the one or more measurement values satisfying one or more thresholds. As an example, a measurement value satisfying a threshold may be indicative of the second network entity 610 having a longer RTT (e.g., a larger pathloss value may indicate a longer RTT or a smaller RSRP may indicate a longer RTT). Therefore, in such cases, the second network entity 610 may re-attempt the random access procedure in accordance with the second random access channel configuration because the second random access channel configuration may be configured or designed for longer RTTs.

Additionally, or alternatively, the second network entity 610 may determine that the one or more conditions are satisfied based on a classification of the second network entity 610. For example, the configuration information may indicate one or more classifications that are permitted to apply the second random access channel configuration. The second network entity 610 may determine that the that the one or more conditions are satisfied based on the classification of the second network entity 610 being included in the one or more classifications that are permitted to apply the second random access channel configuration. A classification may indicate a type, a category, or a class, among other examples, of the second network entity 610. For example, the classification may a category of the second network entity 610 (e.g., indicating a category of device, such as a baseline device, a CPE, a RedCap device, a WAB device, or an NCP), a power classification (e.g., indicating a classification of the level of transmit power), a mobility classification (e.g., stationary, high mobility, low mobility, or medium mobility), or a UAV classification (e.g., indicating whether the second network entity 610 is included in, or associated with, a UAV), among other examples. The one or more classifications that are permitted to apply the second random access channel configuration may be classifications of devices that are more likely to experience longer RTTs. Additionally, or alternatively, the one or more classifications that are permitted to apply the second random access channel configuration may be classifications of devices that can support the second random access channel configuration.

Additionally, or alternatively, the second network entity 610 may determine that the one or more conditions are satisfied based on a quantity of random access attempts performed by the second network entity 610. In some aspects, the quantity of random access attempts may be random access attempts using the second random access channel configuration. The second network entity 610 may determine that the one or more conditions are satisfied based on the quantity of random access attempts satisfying a threshold. As an example, the second random access channel configuration may be available for use if the quantity of random access attempts satisfies the threshold. If the quantity of random access attempts does not satisfy the threshold, then only the first random access channel configuration may be available for use by the second network entity 610.

As shown by reference number 645, the second network entity 610 may transmit, and the first network entity 605 may receive, a second random access communication. The second random access communication may be an initial message of a random access procedure. For example, the random access procedure may be a four-step random access procedure and the second random access communication may be a msg1 communication. In some other aspects, the random access procedure may be a two-step random access procedure and the second random access communication may be a msgA communication.

The second random access communication may be in accordance with the second random access channel configuration based on the one or more conditions being satisfied. For example, the second random access communication may use one or more PRACH resources (e.g., a PRACH occasion) configured for the second random access channel configuration, a PRACH format configured for the second random access channel configuration, or other PRACH resources indicated by the second random access channel configuration to transmit the second random access communication. The second random access communication may include, or indicate, a preamble. The preamble may be associated with a preamble identifier (or a PRACH format) configured for the second random access channel configuration.

For example, the second network entity 610 may re-attempt a random access procedure with the first network entity 605 using the second random access channel configuration based on the one or more conditions being satisfied. In some aspects, the type of random access procedure (e.g., a two-step random access procedure or a four-step random access procedure) associated with the first random access communication (shown by reference number 625) and the second random access communication (shown by reference number 645) may be the same. For example, the random access procedure may be a two-step random access procedure or a four-step random access procedure. In other examples, the type of random access procedure (e.g., a two-step random access procedure or a four-step random access procedure) associated with the first random access communication (shown by reference number 625) and the second random access communication (shown by reference number 645) may be different. For example, the random access procedure associated with the first random access communication (shown by reference number 625) may be a two-step random access procedure and the random access procedure associated with the second random access communication (shown by reference number 645) may be a four-step random access procedure. As another example, the random access procedure associated with the first random access communication (shown by reference number 625) may be a four-step random access procedure and the random access procedure associated with the second random access communication (shown by reference number 645) may be a two-step random access procedure.

In some aspects, the second random access channel configuration may be associated with availability information that indicates one or more time domain resources in which the second random access channel configuration is available for use. The second network entity 610 may transmit the second random access communication during a time domain resource of the one or more time domain resources. For example, the second random access channel configuration may be conditionally available one or more times during a time window. The second network entity 610 may receive the availability information that indicates one or more time domain resources in which the second random access channel configuration is available for use. For example, the availability information may be included in the configuration information, the RAR communication, or another communication.

In some aspects, such as if the first type of random access channel configuration is used, the second network entity 610 may perform timing advance pre-compensation for the second random access communication. The second network entity 610 may transmit, using a random access channel occasion from one or more random access channel occasions configured for the second random access channel configuration, the second random access communication in accordance with the timing advance pre-compensation. For example, the second network entity 610 may determine a timing advance value for the second random access communication based on a cyclic shift gap between preambles associated with the first random access channel configuration. The cyclic shift gap may be an amount of time between two cyclic shifts for preamble sequence generation for consecutive preambles in an order of preamble indexes. By the second network entity 610 using the cyclic shift gap to pre-compensate the timing advance value applied by the second network entity, the second network entity 610 may apply a timing advance value that increases the likelihood of successful reception at the first network entity 605. For example, the RAR communication indicating the next preamble may indicate that the second network entity 610 is experience an RTT or a propagation delay that is causing a misdetection at the first network entity 605 by an amount indicated by the cyclic shift gap (e.g., because the first network entity 605 detects the next preamble when the preamble is transmitted by the second network entity 610). Therefore, the timing advance pre-compensation performed by the second network entity 610 may improve timing synchronization between the first network entity 605 and the second network entity 610.

Although some aspects are described herein using the first random access channel configuration and the second random access channel configuration as an example, the aspects and techniques described herein may be applied for more than two random access channel configurations. For example, the second network entity 610 may receive multiple conditional random access channel configurations (e.g., that are associated with respective ranges of RTTs). As an example, the second network entity 610 may receive a third random access channel configuration that is a conditional random access channel configuration. If the second random access communication (e.g., that is in accordance with the second random access channel configuration) is unsuccessful and the one or more conditions (or other condition(s)) are satisfied, then the second network entity 610 may re-attempt a random access procedure in accordance with the third random access channel configuration. For example, the second network entity 610 may transmit a third random access communication in accordance with the third random access channel configuration.

In some aspects, the first network entity 605 may monitor PRACH resources (e.g., one or more PRACH occasions) associated with the second random access channel configuration. In some aspects, the first network entity 605 may skip monitoring (or refrain from monitoring) one or more of the PRACH resources. For example, a random access occasion associated with the second random access channel configuration may occur after a reception occasion for a subsequent random access communication (e.g., a msg3 communication) associated with the first random access communication. The first network entity 605 may receive the subsequent random access communication during the reception occasion. In such examples, the first network entity 605 may skip monitoring of the random access occasion based on reception of the subsequent random access communication (e.g., because the successful reception of the subsequent random access communication may indicate that no network entities are likely to use the random access occasion). In other words, if the activated/indicated set of PRACH occasions (e.g., for the second random access channel configuration) occur after a msg3 occasion associated with the PRACH occasion used for the first random access communication (or the PRACH occasion associated with the RAR communication), and the first network entity 605 successfully receives a msg3 communication, then there was likely no network entities with a long RTT at this time. Therefore, the first network entity 605 may skip monitoring of the random access occasion(s) for the second random access channel configuration. This conserves energy or processing resources of the first network entity 605 that would have otherwise been used to monitor the random access occasion(s) for the second random access channel configuration when there are likely no network entities with a long RTT at that time.

In some aspects, the first network entity 605 may transmit (and the second network entity 610 may receive) a cancelation notification for the random access occasion based on the reception of the subsequent random access communication. The cancelation notification may indicate that the first network entity 605 is not monitoring the random access occasion(s) for the second random access channel configuration. This may enable the second network entity 610 to skip transmission of a random access communication during the random access occasion(s), thereby conserving network resources or energy resources that would have otherwise been used to transmit the random access communication during a random access occasion that is not being monitored by the first network entity 605.

As shown by reference number 650, if the second random access communication is successful, the first network entity 605 and the second network entity 610 may perform the random access procedure (e.g., may communicate one or more subsequent random access communications). For example, the first network entity 605 and the second network entity 610 may perform the random access procedure in a similar manner as described in connection with FIG. 4 (e.g., for a two-step random access procedure) or FIG. 5 (e.g., for a four-step random access procedure).

In some aspects, the random access procedure may be associated with one or more random access features based on the second network entity 610 using the second random access channel configuration. The one or more random access features may be features that are available for, or associated with, the one or more classifications of network entities that are permitted to apply or use the second random access channel configuration. In some aspects, the one or more random access features may include transmission of an RAR communication that indicates transmission of an early channel state information reference signal transmission (e.g., the use of the second random access channel configuration may trigger early CSI-RS). Additionally, or alternatively, the one or more random access features may include transmission of an RAR communication that requests channel state information feedback (e.g., the use of the second random access channel configuration may trigger a CSI feedback request). Additionally, or alternatively, the one or more random access features may include reception of a subsequent random access communication that includes a reduced-size identifier for the second network entity 610 (e.g., support of a reduced bit-length for identifying the second network entity 610 instead of another identifier in a msg3 communication). The use of the one or more random access features may improve performance or improve resource utilization efficiency for the random access procedure.

As indicated above, FIG. 6 is provided as an example. Other examples may differ from what is described with respect to FIG. 6.

FIG. 7 is a diagram illustrating an example process 700 performed, for example, at a first network entity or an apparatus of a first network entity. Example process 700 is an example where the apparatus or the first network entity (e.g., the second network entity 610, the network entity 102, the network entity 106, or a UE 220) performs operations associated with mixed random access channel configurations.

As shown in FIG. 7, in some aspects, process 700 may include receiving configuration information indicating a first random access channel configuration and a second random access channel configuration (block 710). For example, the first network entity (e.g., using reception component 902 or communication manager 906, depicted in FIG. 9) may receive configuration information indicating a first random access channel configuration and a second random access channel configuration, as described above.

As further shown in FIG. 7, in some aspects, process 700 may include transmitting a first random access communication in accordance with the first random access channel configuration (block 720). For example, the first network entity (e.g., using transmission component 904 or communication manager 906, depicted in FIG. 9) may transmit a first random access communication in accordance with the first random access channel configuration, as described above.

As further shown in FIG. 7, in some aspects, process 700 may include transmitting, based on the first random access communication being unsuccessful and based on one or more conditions being satisfied, a second random access communication in accordance with the second random access channel configuration (block 730). For example, the first network entity (e.g., using transmission component 904 or communication manager 906, depicted in FIG. 9) may transmit, based on the first random access communication being unsuccessful and based on one or more conditions being satisfied, a second random access communication in accordance with the second random access channel configuration, as described above.

Process 700 may include additional aspects, such as any single aspect or any combination of aspects described below or in connection with one or more other processes described elsewhere herein.

In a first aspect, the first random access channel configuration is associated with one or more first round-trip times and the second random access channel configuration is associated with one or more second round-trip times.

In a second aspect, alone or in combination with the first aspect, the one or more first round-trip times satisfy a round-trip time threshold, and where the one or more second round-trip times do not satisfy the round-trip time threshold.

In a third aspect, alone or in combination with one or more of the first and second aspects, the first random access communication indicates a first preamble, and process 700 includes receiving a random access response communication after transmission of the first random access communication, where the random access response communication indicates a second preamble, and where the one or more conditions being satisfied includes the second preamble being a next preamble relative to the first preamble.

In a fourth aspect, alone or in combination with one or more of the first through third aspects, process 700 includes receiving an indication that the second random access channel configuration is available for use, and where the one or more conditions being satisfied includes reception of the indication that the second random access channel configuration is available for use.

In a fifth aspect, alone or in combination with one or more of the first through fourth aspects, the indication that the second random access channel configuration is available for use is included in a random access response communication.

In a sixth aspect, alone or in combination with one or more of the first through fifth aspects, process 700 includes obtaining measurement information based on one or more reference signals, where the one or more conditions being satisfied includes the measurement information indicating one or more values that satisfy a measurement threshold.

In a seventh aspect, alone or in combination with one or more of the first through sixth aspects, the one or more values include at least one of a signal strength value, or a pathloss value.

In an eighth aspect, alone or in combination with one or more of the first through seventh aspects, the one or more conditions being satisfied includes a classification of the first network entity being included in one or more classifications that are associated with the second random access channel configuration.

In a ninth aspect, alone or in combination with one or more of the first through eighth aspects, process 700 includes receiving, prior to transmission of the first random access communication, an indication that the second random access channel configuration is available for use, where the one or more conditions being satisfied includes reception of the indication that the second random access channel configuration is available for use.

In a tenth aspect, alone or in combination with one or more of the first through ninth aspects, the first random access channel configuration and the second random access channel configuration are associated with one or more random access channel occasions.

In an eleventh aspect, alone or in combination with one or more of the first through tenth aspects, transmitting the second random access communication includes performing timing advance pre-compensation for the second random access communication, and transmitting, using a random access channel occasion from the one or more random access channel occasions, the second random access communication in accordance with the timing advance pre-compensation.

In a twelfth aspect, alone or in combination with one or more of the first through eleventh aspects, a value of the timing advance pre-compensation is based on a cyclic shift gap between preambles associated with the first random access channel configuration.

In a thirteenth aspect, alone or in combination with one or more of the first through twelfth aspects, the first random access channel configuration is associated with one or more first random access channel occasions, and where the second random access channel configuration is associated with one or more second random access channel occasions.

In a fourteenth aspect, alone or in combination with one or more of the first through thirteenth aspects, the first random access channel configuration is associated with a first PRACH format, and where the second random access channel configuration is associated with a second PRACH format.

In a fifteenth aspect, alone or in combination with one or more of the first through fourteenth aspects, process 700 includes transmitting a request to make the second random access channel configuration available for use.

In a sixteenth aspect, alone or in combination with one or more of the first through fifteenth aspects, process 700 includes receiving, based on the request, an indication that the second random access channel configuration is available for use, where the one or more conditions being satisfied includes reception of the indication that the second random access channel configuration is available for use.

In a seventeenth aspect, alone or in combination with one or more of the first through sixteenth aspects, the second random access channel configuration includes a first type of random access channel configuration and a second type of random access channel configuration, and where the second random access communication is in accordance with a type from the first type and the second type.

In an eighteenth aspect, alone or in combination with one or more of the first through seventeenth aspects, the type is selected based on at least one of an indication in a random access response communication associated with the first random access communication, an indication included in the configuration information, a classification of the first network entity, or a cause for a random access procedure associated with the first random access communication and the second random access communication.

In a nineteenth aspect, alone or in combination with one or more of the first through eighteenth aspects, the first random access communication is associated with a first type of random access procedure, and where the second random access communication is associated with the first type of random access procedure or a second type of random access procedure.

In a twentieth aspect, alone or in combination with one or more of the first through nineteenth aspects, the first type of random access procedure is a four-step random access procedure, and where the second type of random access procedure is a two-step random access procedure.

In a twenty-first aspect, alone or in combination with one or more of the first through twentieth aspects, the first type of random access procedure is a two-step random access procedure, and where the second type of random access procedure is a four-step random access procedure.

In a twenty-second aspect, alone or in combination with one or more of the first through twenty-first aspects, the second random access channel configuration is associated with availability information that indicates one or more time domain resources in which the second random access channel configuration is available for use.

In a twenty-third aspect, alone or in combination with one or more of the first through twenty-second aspects, transmitting the second random access communication includes transmitting the second random access communication during a time domain resource of the one or more time domain resources.

In a twenty-fourth aspect, alone or in combination with one or more of the first through twenty-third aspects, process 700 includes receiving the availability information.

In a twenty-fifth aspect, alone or in combination with one or more of the first through twenty-fourth aspects, the second random access communication is a part of a random access procedure, and process 700 includes communicating, during the random access procedure, one or more subsequent random access communications in accordance with a random access feature, where the one or more subsequent random access communications being in accordance with the random access feature is based on the second random access communication.

In a twenty-sixth aspect, alone or in combination with one or more of the first through twenty-fifth aspects, the random access feature includes at least one of reception of a random access response communication that indicates transmission of an early channel state information reference signal transmission or that requests channel state information feedback, or transmission of a subsequent random access communication that includes a reduced-size identifier for the first network entity.

In a twenty-seventh aspect, alone or in combination with one or more of the first through twenty-sixth aspects, transmitting the first random access communication includes transmitting the first random access communication to a second network entity, and where transmitting the second random access communication includes transmitting the second random access communication to the second network entity.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a first network entity or an apparatus of a first network entity. Example process 800 is an example where the apparatus or the first network entity (e.g., the first network entity 605, the network entity 102, the network entity 106, or a network node 210) performs operations associated with mixed random access channel configurations.

As shown in FIG. 8, in some aspects, process 800 may include transmitting configuration information indicating a first random access channel configuration and a second random access channel configuration (block 810). For example, the first network entity (e.g., using transmission component 1004 or communication manager 1006, depicted in FIG. 10) may transmit configuration information indicating a first random access channel configuration and a second random access channel configuration, as described above.

As further shown in FIG. 8, in some aspects, process 800 may include receiving a first random access communication in accordance with the first random access channel configuration, where the first random access communication is associated with a second network entity (block 820). For example, the first network entity (e.g., using reception component 1002 or communication manager 1006, depicted in FIG. 10) may receive a first random access communication in accordance with the first random access channel configuration, where the first random access communication is associated with a second network entity, as described above.

As further shown in FIG. 8, in some aspects, process 800 may include receiving, based on one or more conditions being satisfied, a second random access communication in accordance with the second random access channel configuration, where the second random access communication is associated with the second network entity (block 830). For example, the first network entity (e.g., using reception component 1002 or communication manager 1006, depicted in FIG. 10) may receive, based on one or more conditions being satisfied, a second random access communication in accordance with the second random access channel configuration, where the second random access communication is associated with the second network entity, as described above.

Process 800 may include additional aspects, such as any single aspect or any combination of aspects described below or in connection with one or more other processes described elsewhere herein.

In a first aspect, the first random access channel configuration is associated with one or more first round-trip times and the second random access channel configuration is associated with one or more second round-trip times.

In a second aspect, alone or in combination with the first aspect, the one or more first round-trip times satisfy a round-trip time threshold, and where the one or more second round-trip times do not satisfy the round-trip time threshold.

In a third aspect, alone or in combination with one or more of the first through second aspects, process 800 includes transmitting an indication that the second random access channel configuration is available for use, and where the one or more conditions being satisfied includes transmission of the indication that the second random access channel configuration is available for use.

In a fourth aspect, alone or in combination with one or more of the first through third aspects, the indication that the second random access channel configuration is available for use is included in a random access response communication.

In a fifth aspect, alone or in combination with one or more of the first through fourth aspects, the one or more conditions being satisfied includes a classification of the second network entity being included in one or more classifications that are associated with the second random access channel configuration.

In a sixth aspect, alone or in combination with one or more of the first through fifth aspects, process 800 includes transmitting, prior to reception of the first random access communication, an indication that the second random access channel configuration is available for use, where the one or more conditions being satisfied includes transmission of the indication that the second random access channel configuration is available for use.

In a seventh aspect, alone or in combination with one or more of the first through sixth aspects, the first random access channel configuration and the second random access channel configuration are associated with one or more random access channel occasions.

In an eighth aspect, alone or in combination with one or more of the first through seventh aspects, the first random access channel configuration is associated with one or more first random access channel occasions, and where the second random access channel configuration is associated with one or more second random access channel occasions.

In a ninth aspect, alone or in combination with one or more of the first through eighth aspects, the first random access channel configuration is associated with a first PRACH format, and where the second random access channel configuration is associated with a second PRACH format.

In a tenth aspect, alone or in combination with one or more of the first through ninth aspects, process 800 includes receiving a request to make the second random access channel configuration available for use.

In an eleventh aspect, alone or in combination with one or more of the first through tenth aspects, process 800 includes transmitting, based on the request, an indication that the second random access channel configuration is available for use, where the one or more conditions being satisfied includes transmission of the indication that the second random access channel configuration is available for use.

In a twelfth aspect, alone or in combination with one or more of the first through eleventh aspects, the second random access channel configuration includes a first type of random access channel configuration and a second type of random access channel configuration, and where the second random access communication is in accordance with a type from the first type and the second type.

In a thirteenth aspect, alone or in combination with one or more of the first through twelfth aspects, the type is selected based on at least one of an indication in a random access response communication associated with the first random access communication, an indication included in the configuration information, a classification of the second network entity, or a cause for a random access procedure associated with the first random access communication and the second random access communication.

In a fourteenth aspect, alone or in combination with one or more of the first through thirteenth aspects, the first random access communication is associated with a first type of random access procedure, and where the second random access communication is associated with the first type of random access procedure or a second type of random access procedure.

In a fifteenth aspect, alone or in combination with one or more of the first through fourteenth aspects, the first type of random access procedure is a four-step random access procedure, and where the second type of random access procedure is a two-step random access procedure.

In a sixteenth aspect, alone or in combination with one or more of the first through fifteenth aspects, the first type of random access procedure is a two-step random access procedure, and where the second type of random access procedure is a four-step random access procedure.

In a seventeenth aspect, alone or in combination with one or more of the first through sixteenth aspects, the second random access channel configuration is associated with availability information that indicates one or more time domain resources in which the second random access channel configuration is available for use.

In an eighteenth aspect, alone or in combination with one or more of the first through seventeenth aspects, process 800 includes receiving the second random access communication during a time domain resource of the one or more time domain resources.

In a nineteenth aspect, alone or in combination with one or more of the first through eighteenth aspects, process 800 includes transmitting the availability information.

In a twentieth aspect, alone or in combination with one or more of the first through nineteenth aspects, the second random access communication is a part of a random access procedure, and process 800 includes communicating, during the random access procedure, one or more subsequent random access communications in accordance with a random access feature, where the one or more subsequent random access communications being in accordance with the random access feature is based on the second random access communication.

In a twenty-first aspect, alone or in combination with one or more of the first through twentieth aspects, the random access feature includes at least one of transmission of a random access response communication that indicates transmission of an early channel state information reference signal transmission, or that requests channel state information feedback, or reception of a subsequent random access communication that includes a reduced-size identifier for the second network entity.

In a twenty-second aspect, alone or in combination with one or more of the first through twenty-first aspects, a random access occasion associated with the second random access channel configuration occurs after a reception occasion for a subsequent random access communication associated with the first random access communication, and process 800 includes receiving the subsequent random access communication during the reception occasion, and skipping monitoring of the random access occasion based on reception of the subsequent random access communication.

In a twenty-third aspect, alone or in combination with one or more of the first through twenty-second aspects, process 800 includes transmitting a cancelation notification for the random access occasion based on the reception of the subsequent random access communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a network entity, or a network entity may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 114, the communication manager 118, or the communication manager 250. As shown, the apparatus 900 may communicate with another apparatus 908, such as a network entity, a UE, or a network node (such as a CU, a DU, an RU, or a base station), using the reception component 902 and the transmission component 904. The communication manager 906 may be included in, or implemented via, a processing system (for example, the processing system 110, the processing system 112, or the processing system 240).

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components described in connection with FIGS. 1-3. Additionally, or alternatively, one or more components shown in FIG. 9 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components described above in connection with FIGS. 1-3, such as a radio, one or more RF chains, one or more transceivers, or one or more modems, each of which may in turn be coupled with one or more antennas of the network entity.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive configuration information indicating a first random access channel configuration and a second random access channel configuration. The transmission component 904 may transmit a first random access communication in accordance with the first random access channel configuration. The transmission component 904 may transmit, based on the first random access communication being unsuccessful and based on one or more conditions being satisfied, a second random access communication in accordance with the second random access channel configuration.

The reception component 902 may receive an indication that the second random access channel configuration is available for use, and wherein the one or more conditions being satisfied includes reception of the indication that the second random access channel configuration is available for use.

The reception component 902 may obtain measurement information based on one or more reference signals, wherein the one or more conditions being satisfied includes the measurement information indicating one or more values that satisfy a measurement threshold.

The reception component 902 may receive, prior to transmission of the first random access communication, an indication that the second random access channel configuration is available for use, wherein the one or more conditions being satisfied includes reception of the indication that the second random access channel configuration is available for use.

The transmission component 904 may transmit a request to make the second random access channel configuration available for use.

The reception component 902 may receive, based on the request, an indication that the second random access channel configuration is available for use, wherein the one or more conditions being satisfied includes reception of the indication that the second random access channel configuration is available for use.

The reception component 902 may receive the availability information.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 114, the communication manager 118, or the communication manager 255. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 110, the processing system 112, or the processing system 245).

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8, or a combination thereof. In some aspects, the apparatus 1000 or one or more components shown in FIG. 10 may include one or more components described in connection with FIGS. 1-3. Additionally, or alternatively, one or more components shown in FIG. 10 may be implemented within one or more components described in connection with FIGS. 1-3. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components described above in connection with FIGS. 1-3, such as a radio, one or more RF chains, one or more transceivers, or one or more modems, each of which may in turn be coupled with one or more antennas of the network entity.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components described above in connection with FIGS. 1-3, such as a radio, one or more RF chains, one or more transceivers, or one or more modems, each of which may in turn be coupled with one or more antennas described in connection with FIGS. 1-3. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit configuration information indicating a first random access channel configuration and a second random access channel configuration. The reception component 1002 may receive a first random access communication in accordance with the first random access channel configuration, wherein the first random access communication is associated with a second network entity. The reception component 1002 may receive, based on one or more conditions being satisfied, a second random access communication in accordance with the second random access channel configuration, wherein the second random access communication is associated with the second network entity.

The transmission component 1004 may transmit an indication that the second random access channel configuration is available for use, and wherein the one or more conditions being satisfied includes transmission of the indication that the second random access channel configuration is available for use.

The transmission component 1004 may transmit, prior to reception of the first random access communication, an indication that the second random access channel configuration is available for use, wherein the one or more conditions being satisfied includes transmission of the indication that the second random access channel configuration is available for use.

The reception component 1002 may receive a request to make the second random access channel configuration available for use.

The transmission component 1004 may transmit, based on the request, an indication that the second random access channel configuration is available for use, wherein the one or more conditions being satisfied includes transmission of the indication that the second random access channel configuration is available for use.

The reception component 1002 may receive the second random access communication during a time domain resource of the one or more time domain resources.

The transmission component 1004 may transmit the availability information.

The transmission component 1004 may transmit a cancelation notification for the random access occasion based on the reception of the subsequent random access communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first network entity, comprising: receiving configuration information indicating a first random access channel configuration and a second random access channel configuration; transmitting a first random access communication in accordance with the first random access channel configuration; and transmitting, based on the first random access communication being unsuccessful and based on one or more conditions being satisfied, a second random access communication in accordance with the second random access channel configuration.

Aspect 2: The method of Aspect 1, wherein the first random access channel configuration is associated with one or more first round-trip times and the second random access channel configuration is associated with one or more second round-trip times.

Aspect 3: The method of Aspect 2, wherein the one or more first round-trip times satisfy a round-trip time threshold, and wherein the one or more second round-trip times do not satisfy the round-trip time threshold.

Aspect 4: The method of any of Aspects 1-3, wherein the first random access communication indicates a first preamble, the method further comprising receiving a random access response communication after transmission of the first random access communication, wherein the random access response communication indicates a second preamble, and wherein the one or more conditions being satisfied includes the second preamble being a next preamble relative to the first preamble.

Aspect 5: The method of any of Aspects 1-4, further comprising receiving an indication that the second random access channel configuration is available for use, and wherein the one or more conditions being satisfied includes reception of the indication that the second random access channel configuration is available for use.

Aspect 6: The method of Aspect 5, wherein the indication that the second random access channel configuration is available for use is included in a random access response communication.

Aspect 7: The method of any of Aspects 1-6, further comprising obtaining measurement information based on one or more reference signals, wherein the one or more conditions being satisfied includes the measurement information indicating one or more values that satisfy a measurement threshold.

Aspect 8: The method of Aspect 7, wherein the one or more values include at least one of: a signal strength value, or a pathloss value.

Aspect 9: The method of any of Aspects 1-8, wherein the one or more conditions being satisfied includes a classification of the first network entity being included in one or more classifications that are associated with the second random access channel configuration.

Aspect 10: The method of any of Aspects 1-9, further comprising receiving, prior to transmission of the first random access communication, an indication that the second random access channel configuration is available for use, wherein the one or more conditions being satisfied includes reception of the indication that the second random access channel configuration is available for use.

Aspect 11: The method of any of Aspects 1-10, wherein the first random access channel configuration and the second random access channel configuration are associated with one or more random access channel occasions.

Aspect 12: The method of Aspect 11, wherein transmitting the second random access communication comprises: performing timing advance pre-compensation for the second random access communication; and transmitting, using a random access channel occasion from the one or more random access channel occasions, the second random access communication in accordance with the timing advance pre-compensation.

Aspect 13: The method of Aspect 12, wherein a value of the timing advance pre-compensation is based on a cyclic shift gap between preambles associated with the first random access channel configuration.

Aspect 14: The method of any of Aspects 1-13, wherein the first random access channel configuration is associated with one or more first random access channel occasions, and wherein the second random access channel configuration is associated with one or more second random access channel occasions.

Aspect 15: The method of any of Aspects 1-14, wherein the first random access channel configuration is associated with a first physical random access channel (PRACH) format, and wherein the second random access channel configuration is associated with a second PRACH format.

Aspect 16: The method of any of Aspects 1-15, further comprising transmitting a request to make the second random access channel configuration available for use.

Aspect 17: The method of Aspect 16, further comprising receiving, based on the request, an indication that the second random access channel configuration is available for use, wherein the one or more conditions being satisfied includes reception of the indication that the second random access channel configuration is available for use.

Aspect 18: The method of any of Aspects 1-17, wherein the second random access channel configuration includes a first type of random access channel configuration and a second type of random access channel configuration, and wherein the second random access communication is in accordance with a type from the first type and the second type.

Aspect 19: The method of Aspect 18, wherein the type is selected based on at least one of: an indication in a random access response communication associated with the first random access communication, an indication included in the configuration information, a classification of the first network entity, or a cause for a random access procedure associated with the first random access communication and the second random access communication.

Aspect 20: The method of any of Aspects 1-19, wherein the first random access communication is associated with a first type of random access procedure, and wherein the second random access communication is associated with the first type of random access procedure or a second type of random access procedure.

Aspect 21: The method of Aspect 20, wherein the first type of random access procedure is a four-step random access procedure, and wherein the second type of random access procedure is a two-step random access procedure.

Aspect 22: The method of Aspect 20, wherein the first type of random access procedure is a two-step random access procedure, and wherein the second type of random access procedure is a four-step random access procedure.

Aspect 23: The method of any of Aspects 1-22, wherein the second random access channel configuration is associated with availability information that indicates one or more time domain resources in which the second random access channel configuration is available for use.

Aspect 24: The method of Aspect 23, wherein transmitting the second random access communication comprises: transmitting the second random access communication during a time domain resource of the one or more time domain resources.

Aspect 25: The method of Aspect 23, further comprising receiving the availability information.

Aspect 26: The method of any of Aspects 1-25, wherein the second random access communication is a part of a random access procedure, and the method further comprising: communicating, during the random access procedure, one or more subsequent random access communications in accordance with a random access feature, wherein the one or more subsequent random access communications being in accordance with the random access feature is based on the second random access communication.

Aspect 27: The method of Aspect 26, wherein the random access feature includes at least one of: reception of a random access response communication that indicates transmission of an early channel state information reference signal transmission or that requests channel state information feedback, or transmission of a subsequent random access communication that includes a reduced-size identifier for the first network entity.

Aspect 28: The method of any of Aspects 1-27, wherein transmitting the first random access communication comprises transmitting the first random access communication to a second network entity; and wherein transmitting the second random access communication comprises transmitting the second random access communication to the second network entity.

Aspect 29: A method of wireless communication performed by a first network entity, comprising: transmitting configuration information indicating a first random access channel configuration and a second random access channel configuration; receiving a first random access communication in accordance with the first random access channel configuration, wherein the first random access communication is associated with a second network entity; and receiving, based on one or more conditions being satisfied, a second random access communication in accordance with the second random access channel configuration, wherein the second random access communication is associated with the second network entity.

Aspect 30: The method of Aspect 29, wherein the first random access channel configuration is associated with one or more first round-trip times and the second random access channel configuration is associated with one or more second round-trip times.

Aspect 31: The method of Aspect 30, wherein the one or more first round-trip times satisfy a round-trip time threshold, and wherein the one or more second round-trip times do not satisfy the round-trip time threshold.

Aspect 32: The method of any of Aspects 29-31, further comprising transmitting an indication that the second random access channel configuration is available for use, and wherein the one or more conditions being satisfied includes transmission of the indication that the second random access channel configuration is available for use.

Aspect 33: The method of Aspect 32, wherein the indication that the second random access channel configuration is available for use is included in a random access response communication.

Aspect 34: The method of any of Aspects 29-33, wherein the one or more conditions being satisfied includes a classification of the second network entity being included in one or more classifications that are associated with the second random access channel configuration.

Aspect 35: The method of any of Aspects 29-34, further comprising transmitting, prior to reception of the first random access communication, an indication that the second random access channel configuration is available for use, wherein the one or more conditions being satisfied includes transmission of the indication that the second random access channel configuration is available for use.

Aspect 36: The method of any of Aspects 29-35, wherein the first random access channel configuration and the second random access channel configuration are associated with one or more random access channel occasions.

Aspect 37: The method of any of Aspects 29-36, wherein the first random access channel configuration is associated with one or more first random access channel occasions, and wherein the second random access channel configuration is associated with one or more second random access channel occasions.

Aspect 38: The method of any of Aspects 29-37, wherein the first random access channel configuration is associated with a first physical random access channel (PRACH) format, and wherein the second random access channel configuration is associated with a second PRACH format.

Aspect 39: The method of any of Aspects 29-38, further comprising receiving a request to make the second random access channel configuration available for use.

Aspect 40: The method of Aspect 39, further comprising transmitting, based on the request, an indication that the second random access channel configuration is available for use, wherein the one or more conditions being satisfied includes transmission of the indication that the second random access channel configuration is available for use.

Aspect 41: The method of any of Aspects 29-40, wherein the second random access channel configuration includes a first type of random access channel configuration and a second type of random access channel configuration, and wherein the second random access communication is in accordance with a type from the first type and the second type.

Aspect 42: The method of Aspect 41, wherein the type is selected based on at least one of: an indication in a random access response communication associated with the first random access communication, an indication included in the configuration information, a classification of the second network entity, or a cause for a random access procedure associated with the first random access communication and the second random access communication.

Aspect 43: The method of any of Aspects 29-42, wherein the first random access communication is associated with a first type of random access procedure, and wherein the second random access communication is associated with the first type of random access procedure or a second type of random access procedure.

Aspect 44: The method of Aspect 43, wherein the first type of random access procedure is a four-step random access procedure, and wherein the second type of random access procedure is a two-step random access procedure.

Aspect 45: The method of Aspect 43, wherein the first type of random access procedure is a two-step random access procedure, and wherein the second type of random access procedure is a four-step random access procedure.

Aspect 46: The method of any of Aspects 29-45, wherein the second random access channel configuration is associated with availability information that indicates one or more time domain resources in which the second random access channel configuration is available for use.

Aspect 47: The method of Aspect 46, receiving the second random access communication comprises: receiving the second random access communication during a time domain resource of the one or more time domain resources.

Aspect 48: The method of any of Aspects 46-47, further comprising transmitting the availability information.

Aspect 49: The method of any of Aspects 29-48, wherein the second random access communication is a part of a random access procedure, and the method further comprising: communicating, during the random access procedure, one or more subsequent random access communications in accordance with a random access feature, wherein the one or more subsequent random access communications being in accordance with the random access feature is based on the second random access communication.

Aspect 50: The method of Aspect 49, wherein the random access feature includes at least one of: transmission of a random access response communication that indicates transmission of an early channel state information reference signal transmission, or that requests channel state information feedback, or reception of a subsequent random access communication that includes a reduced-size identifier for the second network entity.

Aspect 51: The method of any of Aspects 29-50, wherein a random access occasion associated with the second random access channel configuration occurs after a reception occasion for a subsequent random access communication associated with the first random access communication, and the method further comprising: receiving the subsequent random access communication during the reception occasion; and skipping monitoring of the random access occasion based on reception of the subsequent random access communication.

Aspect 52: The method of Aspect 51, further comprising transmitting a cancelation notification for the random access occasion based on the reception of the subsequent random access communication.

Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.

Aspect 54: An apparatus for wireless communication at a device, the apparatus comprising one or more memories and one or more processors coupled to the one or more memories, the one or more processors configured to cause the device to perform the method of one or more of Aspects 1-52.

Aspect 55: An apparatus for wireless communication, the apparatus comprising at least one means for performing the method of one or more of Aspects 1-52.

Aspect 56: A non-transitory computer-readable medium storing code for wireless communication, the code comprising instructions executable by one or more processors to perform the method of one or more of Aspects 1-52.

Aspect 57: A non-transitory computer-readable medium storing a set of instructions for wireless communication, the set of instructions comprising one or more instructions that, when executed by one or more processors of a device, cause the device to perform the method of one or more of Aspects 1-52.

Aspect 58: A device for wireless communication, the device comprising a processing system that includes one or more processors and one or more memories coupled with the one or more processors, the processing system configured to cause the device to perform the method of one or more of Aspects 1-52.

Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.

Aspect 60: A device comprising a processing system that includes one or more processors and one or more code-storing memories coupled with the one or more processors, the processing system configured to cause the device to perform the method of one or more of Aspects 1-52.

Aspect 61: A device comprising a processing system that includes processor circuitry and code-storing memory circuitry, the processing system configured to cause the device to perform the method of one or more of Aspects 1-52.

Aspect 62: A device for wireless communication, the device comprising a processing system, the processing system configured to perform the method of one or more of Aspects 1-52.

Aspect 63: A non-transitory computer-readable medium having code thereon that, when executed by a device, causes the device to perform the method of one or more of Aspects 1-52.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first network entity, comprising:
a processing system configured to:
receive configuration information indicating a first random access channel configuration and a second random access channel configuration;
transmit a first random access communication in accordance with the first random access channel configuration; and
transmit, based on the first random access communication being unsuccessful and based on one or more conditions being satisfied, a second random access communication in accordance with the second random access channel configuration.

2. The first network entity of claim 1, wherein the first random access channel configuration is associated with one or more first round-trip times and the second random access channel configuration is associated with one or more second round-trip times.

3. The first network entity of claim 1, wherein the first random access communication indicates a first preamble, wherein the processing system is configured to receive a random access response communication after transmission of the first random access communication, wherein the random access response communication indicates a second preamble, and wherein the one or more conditions being satisfied includes the second preamble being a next preamble relative to the first preamble.

4. The first network entity of claim 1, wherein the processing system is configured to receive an indication that the second random access channel configuration is available for use, and wherein the one or more conditions being satisfied includes reception of the indication that the second random access channel configuration is available for use.

5. The first network entity of claim 1, wherein the processing system is configured to obtain measurement information based on one or more reference signals, wherein the one or more conditions being satisfied includes the measurement information indicating one or more values that satisfy a measurement threshold.

6. The first network entity of claim 1, wherein the one or more conditions being satisfied includes a classification of the first network entity being included in one or more classifications that are associated with the second random access channel configuration.

7. The first network entity of claim 1, wherein the processing system is configured to receive, prior to transmission of the first random access communication, an indication that the second random access channel configuration is available for use, wherein the one or more conditions being satisfied includes reception of the indication that the second random access channel configuration is available for use.

8. The first network entity of claim 1, wherein the first random access channel configuration and the second random access channel configuration are associated with one or more random access channel occasions.

9. The first network entity of claim 8, wherein, to transmit the second random access communication, the processing system is configured to:
perform timing advance pre-compensation for the second random access communication; and
transmit, using a random access channel occasion from the one or more random access channel occasions, the second random access communication in accordance with the timing advance pre-compensation.

10. The first network entity of claim 1, wherein the first random access channel configuration is associated with one or more first random access channel occasions, and wherein the second random access channel configuration is associated with one or more second random access channel occasions.

11. The first network entity of claim 1, wherein the first random access channel configuration is associated with a first physical random access channel (PRACH) format, and wherein the second random access channel configuration is associated with a second PRACH format.

12. The first network entity of claim 1, wherein the processing system is configured to transmit a request to make the second random access channel configuration available for use.

13. The first network entity of claim 1, wherein the second random access channel configuration includes a first type of random access channel configuration and a second type of random access channel configuration, and wherein the second random access communication is in accordance with a type from the first type and the second type.

14. The first network entity of claim 1, wherein the first random access communication is associated with a first type of random access procedure, and wherein the second random access communication is associated with the first type of random access procedure or a second type of random access procedure.

15. The first network entity of claim 1, wherein the second random access channel configuration is associated with availability information that indicates one or more time domain resources in which the second random access channel configuration is available for use.

16. The first network entity of claim 1, wherein the second random access communication is a part of a random access procedure, and wherein the processing system is configured to:
communicate, during the random access procedure, one or more subsequent random access communications in accordance with a random access feature, wherein the one or more subsequent random access communications being in accordance with the random access feature is based on the second random access communication.

17. The first network entity of claim 1, wherein, to transmit the first random access communication, the processing system is configured to transmit the first random access communication to a second network entity; and
wherein, to transmit the second random access communication, the processing system is configured to transmit the second random access communication to the second network entity.

18. A first network entity, comprising:
a processing system configured to:
transmit configuration information indicating a first random access channel configuration and a second random access channel configuration;
receive a first random access communication in accordance with the first random access channel configuration, wherein the first random access communication is associated with a second network entity; and
receive, based on one or more conditions being satisfied, a second random access communication in accordance with the second random access channel configuration, wherein the second random access communication is associated with the second network entity.

19. The first network entity of claim 18, wherein the first random access channel configuration is associated with one or more first round-trip times and the second random access channel configuration is associated with one or more second round-trip times.

20. A method of wireless communication performed by a first network entity, comprising:
receiving configuration information indicating a first random access channel configuration and a second random access channel configuration;
transmitting a first random access communication in accordance with the first random access channel configuration; and
transmitting, based on the first random access communication being unsuccessful and based on one or more conditions being satisfied, a second random access communication in accordance with the second random access channel configuration.
